(19) United States
(12) Patent Application Publication
(10) Pub. No.: US 2018/0356965 A1
(43) Pub. Date: Dec. 13, 2018

(54) USER INTERFACE DEVICE, DISPLAY CONTROL METHOD, AND PROGRAM

(71) Applicant: ALPS ELECTRIC CO., LTD., Tokyo (JP)

(72) Inventors: Yasuji Hagiwara, Miyagi-ken (JP); Daisuke Takai, Tokyo (JP); Yoshiyuki Kikuchi, Miyagi-ken (JP); Kazuhito Oshita, Miyagi-ken (JP); Mitsuo Makino, Miyagi-ken (JP); Hiroshi Shigetaka, Miyagi-ken (JP)

(21) Appl. No.: 16/004,856

(22) Filed: Jun. 11, 2018

(30) Foreign Application Priority Data
Jun. 12, 2017 (JP) 2017-115510

(51) Int. Cl. G06F 3/0484; G06F 3/041; G06F 3/01; G06F 3/0488

(52) U.S. Cl. CPC G06F 3/04845; G06F 3/0414; G06F 3/04817; G06F 3/016; G06F 3/0488; G06F 3/0416

(57) ABSTRACT

A controller identifies, when a contact position of a finger is detected by a detector, an object on a screen of a display device designated by the contact made on an input surface, on the basis of the contact position detected by the detector. When the object on the screen is identified, the control unit selects the object as an object to be moved, according to pressing force detected by the detector. When the contact position detected by the detector moves, with the object on the screen kept selected as the object to be moved, the controller moves such object to be moved on the screen, according to the movement of the contact position.

### CLAIM OF PRIORITY

This application claims benefit of priority to Japanese Patent Application No. 2017-115510 filed on Jun. 12, 2017, which is hereby incorporated by reference in its entirety.

### BACKGROUND

### 1. Field of the Disclosure

The present disclosure relates to a user interface device that controls a display on a screen of a display device according to an input operation, and a display control method and a program for the user interface device.

### 2. Description of the Related Art

Recently, apparatuses having an input interface, for example a touch pad or a touch panel, for detecting a contact position of an object such as a finger or a pen, have come to be widely used. Japanese Unexamined Patent Application Publication No. 2010-134938 discloses a mobile information apparatus that identifies a type of operation, on the basis of a movement history of the finger contacting the touch panel and, for example, enlarges or reduces a map image according to the type of operation identified.

The apparatuses that include a touch panel as the input interface, like the mobile information apparatus according to the cited document, are advantageous in allowing intuitive operation, compared with apparatuses accompanied with a mouse or the like. However, when a complicated operation has to be performed, a set of mouse and keyboard is often easier to operate than the touch pad or touch panel, and therefore the input interface such as the touch pad or touch panel is desired to be more user-friendly.

### SUMMARY

A first aspect of the present disclosure relates to a user interface device that controls a display on a screen of a display device, according to a contact on an input surface. The user interface device includes a detector configured to detect a contact position on the input surface and a pressing force applied to the input surface owing to the contact, and a controller configured to control a display on the screen according a detection result provided by the detector. The controller is configured to identify, as a designated object, at least an object on the screen designated by the contact made on the input surface, on a basis of the detection result of the contact position provided by the detector, select at least one designated object as an object to be moved, according to the pressing force detected by the detector, and move, when the contact position moves, with the object to be moved kept selected, the object to be moved on the screen according to the movement of the contact position.

In the mentioned user interface device, at least an object on the screen, designated by the contact made on the input surface, is identified as the designated object, on the basis of the detection result of the contact position provided by the detector. Then, at least one designated object is selected as the object to be moved, according to the pressing force detected by the detector. Thus, the object to be moved is selected out of the objects on the screen, on the basis of the detection result of the contact position and the pressing force on the input surface. Such an arrangement facilitates the selection of the object to be moved.

A second aspect of the present disclosure relates to a user interface device that controls a display on a screen of a display device, according to a contact on an input surface. The user interface device includes a detector configured to detect a contact position on the input surface and a pressing force applied to the input surface owing to the contact, a controller configured to control a display on the screen according a detection result provided by the detector. The controller is configured to move, when the contact position detected by the detection unit moves, at least part of the objects displayed on the screen according to the movement of the contact position, and change, when moving the at least part of the objects, a relation between an operation stroke corresponding to a movement distance of the contact position on the screen and an object travel corresponding to a movement distance of the at least part of the objects, according to the pressing force detected by the detector.

In the mentioned user interface device, when at least part of the objects displayed on the screen is to be moved according to the movement of the contact position, the relation between the operation stroke and the object travel is changed according to the pressing force. When the moving speed of the contact position is constant, the longer the object travel is with respect to the operation stroke, the faster the object moves, and the shorter the object travel is with respect to the operation stroke, the slower the object moves. Therefore, the user can control the moving speed of the object by adjusting the pressing force.

A third aspect of the present disclosure relates to a user interface device that controls a display on a screen of a display device, according to a contact on an input surface. The user interface device includes a detector configured to detect a contact position on the input surface and a pressing force applied to the input surface owing to the contact, and a controller configured to control a display on the screen according a detection result provided by the detector. The controller is configured to identify, as a designated object, at least an object on the screen designated by the contact made on the input surface, on a basis of a detection result of the contact position provided by the detector, select at least one designated object as an object to be moved, according to the pressing force detected by the detector, and change at least one of a display size of the at least one designated object and displayed details of information accompanying the at least one designated object, according to the pressing force detected by the detector.

In the mentioned user interface device, at least an object on the screen is identified as the designated object, on the basis of the detection result of the contact position provided by the detector. In addition, at least one of the display size of the designated object and the displayed details of the information accompanying the designated object is changed, according to the pressing force. Thus, the display size of the designated object, and/or the displayed details of the accompanying information are changed, on the basis of the contact position and the pressing force on the input surface. Such an arrangement facilitates the changing of the display size of the designated object, and/or the displayed details of the accompanying information.

A fourth aspect of the present disclosure relates to a display control method for controlling a display on a screen of a display device, according to a contact on an input surface. The display control method includes acquiring a detection result from a detector configured to detect a contact position on the input surface and a pressing force applied to the input surface owing to the contact, identifying, as a designated object, at least an object on the screen designated by the contact made on the input surface, on a basis of the detection result of the contact position provided by the detector, selecting at least one designated object as an object to be moved, according to the pressing force detected by the detector, and moving, when the contact position moves, with the object to be moved kept selected, the object to be moved on the screen according to the movement of the contact position.

### BRIEF DESCRIPTION OF THE DRAWINGS

FIG. 1A is a perspective view showing an appearance of a user interface device according to a first embodiment;

FIG. 1B is a partial cross-sectional view of a detection unit;

FIG. 2 is a block diagram showing a configuration of the user interface device according to the first embodiment;

FIG. 3 is a flowchart for explaining an operation of the user interface device according to the first embodiment;

FIG. 4 is a flowchart for explaining further details of a process in the flowchart of FIG. 3, regarding selection of an object to be moved;

FIG. 5 is a flowchart for explaining further details of a process in the flowchart of FIG. 4, regarding selection of the object to be moved according to pressing force;

FIG. 6A to FIG. 6D are schematic drawings for explaining an example of the process of the flowchart of FIG. 5, regarding selection of the object to be moved according to the pressing force, out of a plurality of objects overlapping on a screen;

FIG. 7 is a flowchart for explaining further details of a process in the flowchart of FIG. 4, regarding presentation of tactile feeling;

FIG. 8 is a flowchart for explaining a variation of the operation to select the object to be moved according to the pressing force, performed by the user interface device according to the first embodiment;

FIG. 9A to FIG. 9D are schematic drawings for explaining an example of the process of the flowchart of FIG. 8, regarding selection of the object to be moved according to the pressing force, out of a plurality of objects that are different in area;

FIG. 10 is a flowchart for explaining another variation of the operation to select the object to be moved according to the pressing force, performed by the user interface device according to the first embodiment;

FIG. 11 is a flowchart for explaining another variation of the operation to select the object to be moved, performed by the user interface device according to the first embodiment;

FIG. 12 is a flowchart for explaining further details of a process in the flowchart of FIG. 11, regarding a variation of the operation to select the object to be moved according to pressing force;

FIG. 13 is a flowchart for explaining another variation of the operation to select the object to be moved, performed by the user interface device according to the first embodiment;

FIG. 14 is a flowchart for explaining an operation of a user interface device according to a second embodiment;

FIG. 15 is a flowchart for explaining further details of a process in the flowchart of FIG. 14, regarding changing a relation between an operation stroke and an object travel, according to the pressing force;

FIG. 16 is a schematic drawing for explaining an example of the process of the flowchart of FIG. 15, for changing the relation between the operation stroke and the object travel, according to the pressing force;

FIG. 17A to FIG. 17C are schematic drawings for explaining another example of the process of the flowchart of FIG. 15, for changing the relation between the operation stroke and the object travel, according to the pressing force;

FIG. 18 is a flowchart for explaining a variation of the operation of the user interface device according to the second embodiment;

FIG. 19 is a flowchart for explaining further details of a process in the flowchart of FIG. 18, regarding presentation of the tactile feeling;

FIG. 20 is a flowchart for explaining an operation of a user interface device according to a third embodiment;

FIG. 21 is a flowchart for explaining further details of a process in the flowchart of FIG. 20, regarding changing a display size of the object;

FIG. 22A to FIG. 22D are schematic drawings for explaining an example of the process of the flowchart of FIG. 21, for changing the display size of an icon, according to the pressing force;

FIG. 23A to FIG. 23D are schematic drawings for explaining another example of the process of the flowchart of FIG. 21, for changing the display size of an icon in a folder, according to the pressing force;

FIG. 24A to FIG. 24D are schematic drawings for explaining another example of the process of the flowchart of FIG. 21, for changing the contents of a file displayed in a preview window, according to the pressing force;

FIG. 25 is a flowchart for explaining further details of a process in the flowchart of FIG. 20, regarding presentation of the tactile feeling;

FIG. 26 is a flowchart for explaining a variation of the operation of the user interface device according to the third embodiment;

FIG. 27 is a flowchart for explaining another variation of the operation of the user interface device according to the third embodiment;

FIG. 28 is a flowchart for explaining further details of a process in the flowchart of FIG. 27, regarding changing displayed details of accompanying information; and

FIG. 29A to FIG. 29C are schematic drawings for explaining an example of the process of the flowchart of FIG. 28, for changing the displayed details of the accompanying information, according to the pressing force.

### DESCRIPTION OF THE EXEMPLARY EMBODIMENTS

### First Embodiment

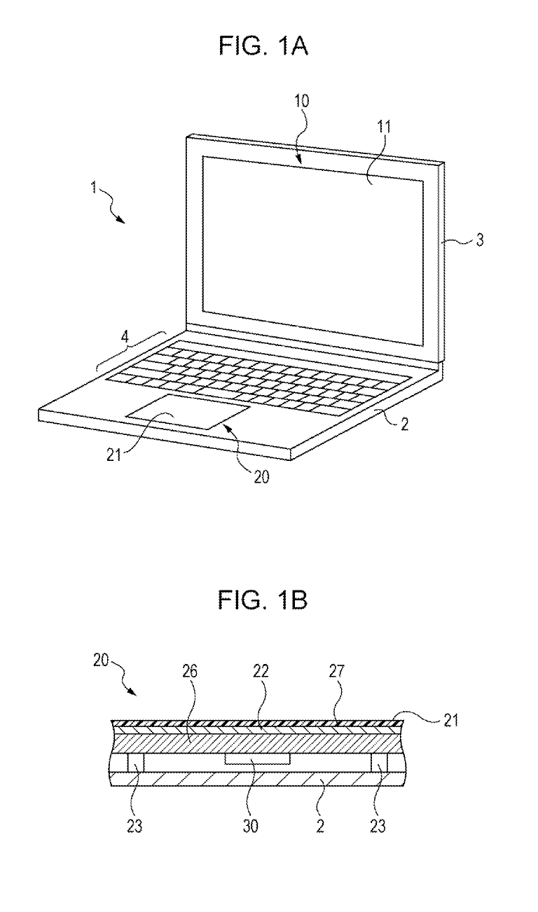

Hereafter, a user interface device according to a first embodiment will be described with reference to the drawings. FIG. 1A is a perspective view showing an appearance of the user interface device according to the first embodiment. The user interface device 1 shown in FIG. 1A is a laptop type personal computer, and includes a main body 2 and a lid member 3, foldably connected via a hinge mechanism. The main body 2 includes a keyboard 4 having a plurality of input keys, and a detection unit 20 that detects an input operation performed on an input surface 21. The lid member 3 includes a display device 10 such as a liquid crystal display or an organic EL display. The user interface device 1 controls the display on a screen 11 of the input surface 21, according to inputs through the keyboard 4 and contacts on the detection unit or detector 20.

The detector 20 detects, when for example a finger of a user contacts the input surface 21, the contact position of the finger on the input surface 21 and the pressing force applied to the input surface 21 owing to the contact. FIG. 1B is a partial cross-sectional view of the detection unit 20, taken in a vertical direction in FIG. 1A. In the example shown in FIG. 1B, the detection unit 20 includes an electrostatic sensor 22 and a pressure sensor 23. The electrostatic sensor 22 serves to detect a change in electrostatic capacitance, originating from a contact by an object on the input surface 21. The electrostatic sensor 22 includes a circuit board having a plurality of electrodes formed thereon for detecting a change in electrostatic capacitance, and has one surface covered with a cover member 27, for example formed of a resin, and the other surface supported by a support member 26. The cover member 27 is exposed on the front face of the main body 2, and the exposed surface serves as the input surface 21. The support member 26 is configured to be displaced by a minute amount in a vertical direction of the main body 2 (perpendicular to the input surface 21), and serves to support the cover member 27 and the electrostatic sensor 22 from below.

The pressure sensor 23 serves to detect the pressing force imposed from the input surface 21 through the support member and, for example, includes a piezoelectric element. The pressure sensor 23 is located, for example as shown in FIG. 1B, at each of a plurality of positions between the bottom plate of the main body 2 and the support member 26. The pressure sensor 23 detects a force exerted by a minute displacement of the support member 26, as the pressing force.

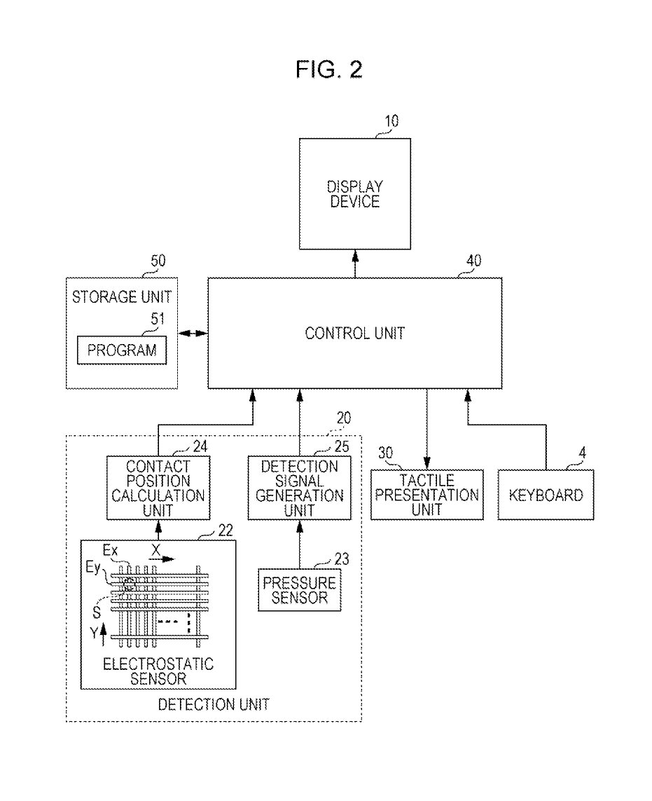

FIG. 2 is a block diagram showing a configuration of the user interface device according to the first embodiment. The user interface device 1 shown in FIG. 2 includes the display device 10, the detection unit 20, a tactile presentation unit 30, a controller or control unit 40, and a storage unit 50. The detection unit 20 includes the electrostatic sensor 22, the pressure sensor 23, a contact position calculation unit 24, and a detection signal generation unit 25.

The electrostatic sensor 22 includes, as shown in FIG. 2, a plurality of electrodes Ex each extending in the vertical direction (Y-direction in FIG. 2) and a plurality of detection electrodes Ey each extending in a transverse direction (X-direction in FIG. 2). The plurality of electrodes Ex are aligned parallel to each other in the transverse direction, and the plurality of electrodes Ey are aligned parallel to each other in the vertical direction. The electrodes Ex and the electrodes Ey intersect in a grid pattern, and insulated from each other. At each of the intersections of the electrode Ex and the electrode Ey, a capacitive sensor element S is formed. When the finger of the user contacts the input surface 21, the electrostatic capacitance changes in the capacitive sensor element S located close to the contact position. Although the electrodes (Ex, Ey) constitute a rectangular grid pattern in FIG. 2, different patterns, such as a diamond pattern, may be adopted.

The contact position calculation unit 24 detects the change in electrostatic capacitance generated in each of the capacitive sensor elements S of the electrostatic sensor 22, owing to the contact of, for example, a finger on the input surface 21, and calculates the contact position of the finger on the input surface 21, on the basis of the detection result.

For example, the contact position calculation unit 24 sequentially applies a drive voltage to each of the electrodes Ex, and detects a charge supplied to the capacitive sensor element S from the electrode Ey because of the application of the drive voltage, to thereby detect the electrostatic capacitance of the capacitive sensor element S proportional to the charge. The contact position calculation unit 24 decides whether the finger has contacted the input surface 21 with respect to each of a plurality of positions, on the basis of data of a plurality of electrostatic capacitance values detected with respect to the plurality of capacitive sensor elements S. The contact position calculation unit 24 identifies the contact range of the finger on the input surface 21 from the decision result whether a contact has been made, and calculates the contact position of the finger on the basis of the contact range identified as above. The contact position calculation unit 24 includes, for example, a drive circuit that supplies the drive voltage to the electrostatic sensor 22, a charge amplifier that detects the charge of each capacitive sensor element S, an AD converter that converts an output signal of the charge amplifier to a digital value, and a signal processing circuit (e.g., computer and exclusive logic circuit) that calculates the contact position on the basis of the electrostatic capacitance value obtained from the AD converter.

Although the mentioned electrostatic sensor 22 is configured to detect an approaching object on the basis of a change in electrostatic capacitance taking place between the electrodes (Ex, Ey) (mutual capacitance), the approaching of an object may be detected by different methods. For example, the electrostatic sensor 22 may be based on a self-capacitance method, to detect the electrostatic capacitance generated between the electrode and the ground, when an object comes close.

The detection signal generation unit 25 generates a detection signal indicating the value of the pressing force, on the basis of a physical amount detected by the pressure sensor 23. The detection signal generation unit 25 includes, for example, a charge amplifier that detects a charge generated by the piezoelectric element of the pressure sensor 23, an AD converter that converts an output signal of the charge amplifier to a digital value, and a signal processing circuit (e.g., computer and exclusive logic circuit) that corrects the digital value and generates the detection signal of the pressing force.

The tactile presentation unit 30 presents tactile feeling to the user's finger brought into contact with the input surface 21. The tactile presentation unit 30 includes an actuator, such as a piezoelectric oscillator or a solenoid. In the example shown in FIG. 1B, the tactile presentation unit 30 is attached to the lower surface of the support member 26, and transmits oscillation to the cover member 27, through the support member 26 and the electrostatic sensor 22.

Here, the tactile feeling to be presented by the tactile presentation unit 30 is not limited to the oscillation but, for example, an electrostatic force or heat (warm or cool effect) may be presented as the tactile feeling.

The controller or control unit 40 serves to control the overall operation of the user interface device 1, and includes, for example, a computer that executes processings according to a program 51 (e.g., operating system, application software, and device driver) stored in the storage unit 50. The control unit 40 may also include an exclusive logic circuit configured to execute predetermined processings.

The control unit 40 may utilize the computer to execute all of the processings related to the display control of the screen 11, to be subsequently described, or utilize the exclusive logic circuit to execute at least a part of the processings.

The control unit 40 controls the display on the screen 11, according to the detection result (contact position and pressing force) provided by the detection unit 20. To be more detailed, the control unit 40 identifies, as a designated object, at least one object on the screen 11 designated by a contact made on the input surface 21, on the basis of the detection result of the contact position of the finger, provided by the detection unit 20. For example, the control unit 40 updates, when the detection unit 20 detects a contact of the finger on the input surface 21, the position of a cursor (pointer) displayed on the screen 11 of the display device 10, according to the detection result of the contact position. In this case, the control unit 40 identifies, as the designated object, an object such as an icon located at the position corresponding to the cursor, made to move on the screen 11 by the contact made on the input surface 21. The control unit 40 may identify the designated object each time the position of the cursor is updated, or when the cursor remains at a given position for a predetermined time or longer. Alternatively, the control unit 40 may identify the designated object when the pressing force detected by the detection unit 20 is larger than a predetermined threshold.

The control unit 40 also selects the designated object as an object to be moved, according to the pressing force detected by the detection unit 20. For example, when the pressing force detected by the detection unit 20 is larger than the predetermined threshold, the control unit 40 selects the designated object identified on the basis of the contact position, as the object to be moved. When the contact position detected by the detection unit 20 moves, with at least one designated object kept selected as the object to be moved, the control unit 40 moves such object to be moved on the screen 11, according to the movement of the contact position.

The control unit 40 may identify a plurality of objects on the screen 11 as the designated object, on the basis of the detection result of the contact position of the finger, detected by the detection unit 20. The control unit 40 selects at least one designated object as the object to be moved out of the plurality of designated objects, according to the pressing force detected by the detection unit 20. For example, the control unit 40 increases the number of the designated objects to be selected as the object to be moved out of the plurality of designated objects, with an increase in the pressing force detected by the detection unit 20. More specifically, when the plurality of designated objects identified as above overlap on the screen 11, the control unit 40 expands the range of the designated objects to be selected as the object to be moved, from the designated object on the front side toward another one on the rear side, with the increase in the pressing force detected by the detection unit 20.

When at least one designated object is selected as the object to be moved, the control unit 40 controls the tactile presentation unit 30 so as to present continuous tactile feeling, to notify that the object to be moved has been selected. For example, the control unit 40 controls the tactile presentation unit 30 so as to present the heavier tactile feeling, the larger number of designated objects are selected as the object to be moved. More specifically, the control unit 40 reduces the frequency, and increases the amplitude, of the oscillation transmitted as the tactile feeling, with the increase in the number of designated objects selected as the object to be moved. The control unit 40 may control the frequency and amplitude of the oscillation, for example by selectively driving one or more oscillators, out of a plurality of oscillators provided in the tactile presentation unit 30.

When at least one designated object is selected as the object to be moved, the control unit 40 may deselect the designated object as the object to be moved, depending on the pressing force detected by the detection unit 20. For example, when at least one designated object is selected as the object to be moved, the control unit 40 deselects the designated object as the object to be moved, in the case where the pressing force detected by the detection unit 20 is below a predetermined threshold.

In addition, when at least one designated object is selected as the object to be moved, the control unit 40 deselects the designated object as the object to be moved, in the case where the detection unit 20 stops detecting the contact position.

The storage unit 50 stores therein the program 51 configured to cause the computer of the control unit 40 to execute the processings, and data to be used for the processings executed by the control unit 40. The storage unit 30 includes, for example, volatile memories such as a DRAM and a SRAM, non-volatile memories such as a flash memory, and a hard disk.

The program 51 may be downloaded from an external apparatus (e.g., server apparatus) through a non-illustrated communication interface, or inputted from a physical non-transitory medium (e.g., optical disk and USB memory), through a non-illustrated input device.

Hereunder, an operation of the user interface device 1 configured as above according to the first embodiment will be described.

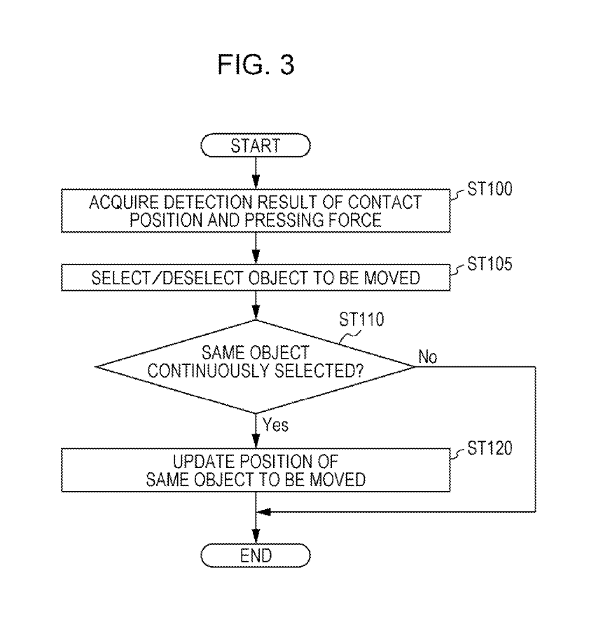

FIG. 3 is a flowchart for explaining the operation of the user interface device 1 according to the first embodiment, related to moving the object on the screen 11 according to the detection result provided by the detection unit 20. The user interface device 1 repeatedly performs the processes shown in FIG. 3.

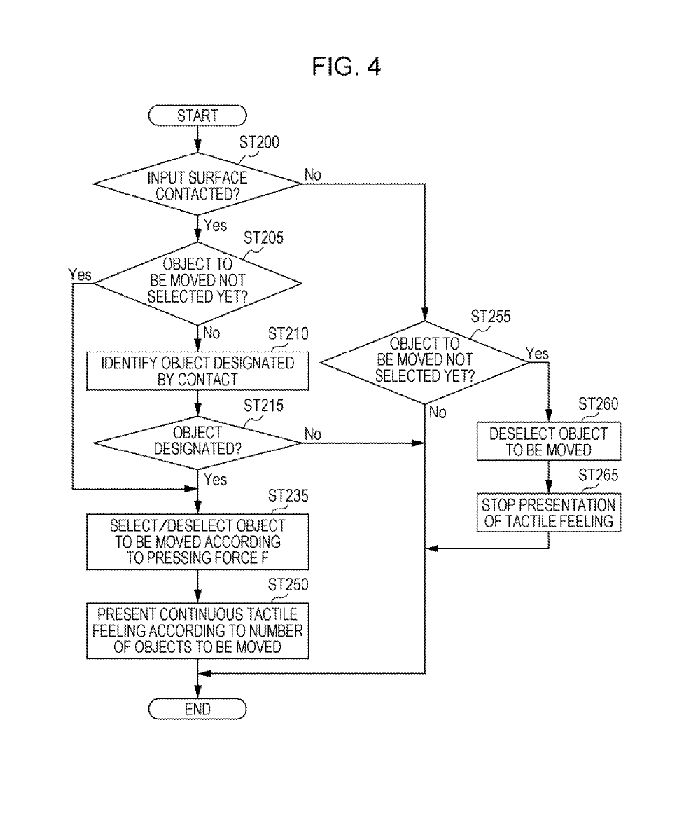

First, the control unit 40 acquires the detection result of the contact position and the pressing force on the input surface 21, from the detection unit 20 (ST100). Upon acquiring the detection result from the detection unit 20, the control unit 40 selects the object to be moved out of the objects displayed on the screen 11, and also deselects the object as the object to be moved, on the basis of the detection result (ST105). Further details of step ST105 will be subsequently described, with reference to FIG. 4.

After selecting or deselecting the object to be moved, the control unit 40 updates, in the case where any object to be moved remains selected through the previous and the current process (Yes at ST110), the position of such object to be moved (ST120). For example, the control unit 40 calculates a direction and a distance, in and by which the contact position has moved on the input surface 21, on the basis of the previously detected contact position on the input surface 21 and the currently detected contact position on the input surface 21. The control unit 40 calculates a coordinate on the screen 11 to which the object to be moved is supposed to move, on the basis of the direction and the distance in and by which the contact position has moved, and moves the object to be moved to the coordinate.

FIG. 4 is a flowchart for explaining further details of the process of ST105 in the flowchart of FIG. 3, regarding the selection of the object to be moved.

The control unit 40 decides whether a contact has been made on the input surface 21, on the basis of the detection result of the contact position provided by the detection unit 20 (ST200). In the case where a contact has been made on the input surface 21 (Yes at ST200), the control unit 40 checks whether any designated object has been selected as the object to be moved (ST205). In the case where a designated object has been selected as the object to be moved (Yes at ST205), the control unit 40 proceeds to step ST235 and ST250.

In the case where no designated object has been selected as the object to be moved (No at ST205), the control unit 40 identifies the object on the screen 11 designated by the contact made on the input surface 21, as the designated object (ST210). For example, the control unit 40 identifies the object located at the position overlapping the cursor (pointer) indicating the pointed object, as the designated object. When a plurality of objects are located at the position overlapping the cursor, the control unit 40 may identify each of the plurality of objects as the designated object.

In the case where a touch panel, in which the screen 11 of the display device 10 and the input surface 21 of the detection unit 20 are integrated, is employed, the control unit 40 may identify, for example, an object displayed at the contact position as the designated object.

The control unit 40 then decides whether any designated object (object designated by the contact made on the input surface 21) has been identified at step ST210 (ST215). In the case where a designated object has been identified at step ST210 (Yes at ST215), the control unit 40 proceeds to step ST235 and ST250. In contrast, in the case where no designated object has been identified at step ST210 (No at ST215), the control unit 40 finishes the operation instead of proceeding to step ST235 and ST250, because the control unit 40 is unable to select or deselect the object to be moved.

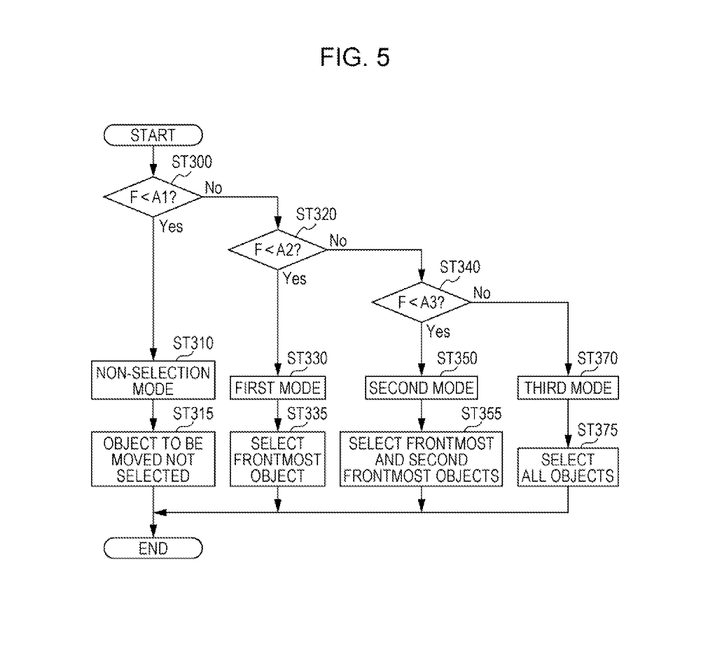

At step ST235, the control unit 40 selects and deselects the object to be moved, according to the detection result of the pressing force provided by the detection unit 20. Further details of step ST235 will be subsequently described, with reference to FIG. 5.

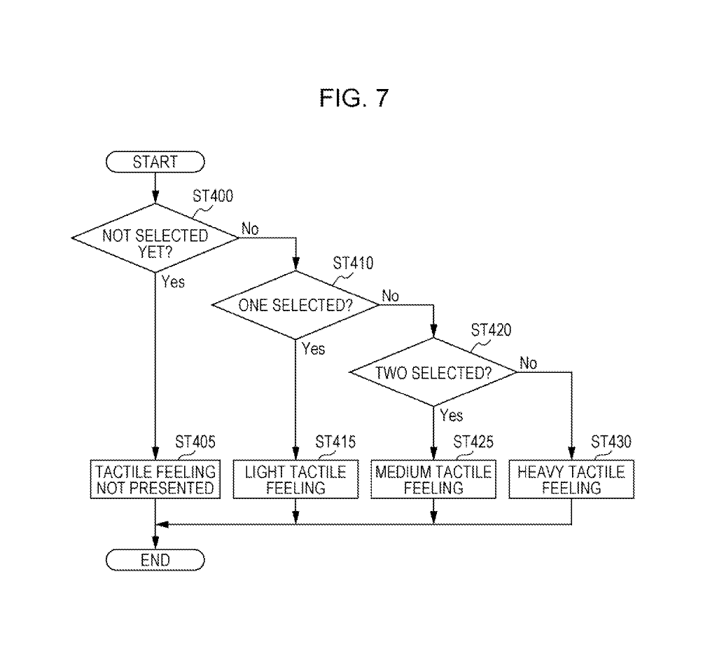

After step ST235, the control unit 40 controls the tactile presentation unit 30 so as to present the tactile feeling that matches the number of the object to be moved that have been selected (ST250). Further details of step ST250 will be subsequently described, with reference to FIG. 7.

Upon deciding at step ST200 that no contact has been made on the input surface 21 (No at ST200), the control unit 40 checks whether any designated object has been selected as the object to be moved (ST255). In the case where no designated object has been selected as the object to be moved (No at ST255), the control unit 40 finishes the operation. In contrast, in the case where a designated object has been selected as the object to be moved (Yes at ST255), the control unit 40 deselects such designated object as the object to be moved (ST260), and causes the tactile presentation unit 30 to stop presenting the tactile feeling (ST265). Therefore, the object on the screen 11 can be deselected as the object to be moved, simply by stopping touching the input surface 21.

Although the flowchart of FIG. 4 specifies that the designated object is not identified (ST210) in the case where no designated object has been selected as the object to be moved (No at ST205), the designated object may be identified irrespective of whether any designated object has been selected as the object to be moved, according to another example of this embodiment. Alternatively, the designated object may be identified in the case where the detection result of the pressing force is larger than a predetermined minimum threshold, at step ST235 described hereunder.

FIG. 5 is a flowchart for explaining further details of the process of ST235 in the flowchart of FIG. 4, regarding the selection of the object to be moved according to the pressing force.

The control unit 40 compares the pressing force detected by the detection unit 20 with a threshold A1 (ST300). A code “F” in the flowchart of FIG. 5 denotes the pressing force detected (hereinafter, “pressing force F” as the case may be). When the pressing force F is smaller than the threshold A1 (Yes at ST300), the control unit 40 proceeds to a “non-selection mode” (ST310). In the non-selection mode, the control unit 40 does not select the object to be moved (ST315).

When the pressing force F is equal to or larger than the threshold A1 (No at ST300), the control unit 40 compares the pressing force F with a threshold A2 (A2>A1) (ST320). When the pressing force F is smaller than the threshold A2 (Yes at ST320), the control unit 40 proceeds to a “first mode” (ST330). In the first mode, the control unit 40 selects the frontmost designated object as the object to be moved, out of the designated objects (objects designated by the contact made on the input surface 21) identified at step ST210 (ST335). In the case where, for example, one designated object has been identified at step ST210, the control unit 40 selects the one designated object as the object to be moved. In the case where two or more designated objects have been identified at step ST210, the control unit 40 selects the frontmost designated object as the object to be moved, but not the remaining designated objects.

When the pressing force F is equal to or larger than the threshold A2 (No at ST320), the control unit 40 compares the pressing force F with a threshold A3 (A3>A2) (ST340). When the pressing force F is smaller than the threshold A3 (Yes at ST340), the control unit 40 proceeds to a “second mode” (ST350). In the second mode, the control unit 40 selects the frontmost and second frontmost designated objects as the object to be moved, out of the designated objects identified at step ST210 (ST355). In the case where, for example, one designated object has been identified at step ST210, the control unit 40 selects the one designated object as the object to be moved. In the case where two designated objects have been identified at step ST210, the control unit 40 selects the two designated objects as the object to be moved. In the case where three or more designated objects have been identified at step ST210, the control unit 40 selects the frontmost and second frontmost designated objects as the object to be moved, but not the remaining designated objects.

When the pressing force F is equal to or larger than a threshold A3 (No at ST340), the control unit 40 proceeds to a “third mode” (ST370). In the third mode, the control unit 40 selects all the designated objects identified at step ST210, as the object to be moved (ST375).

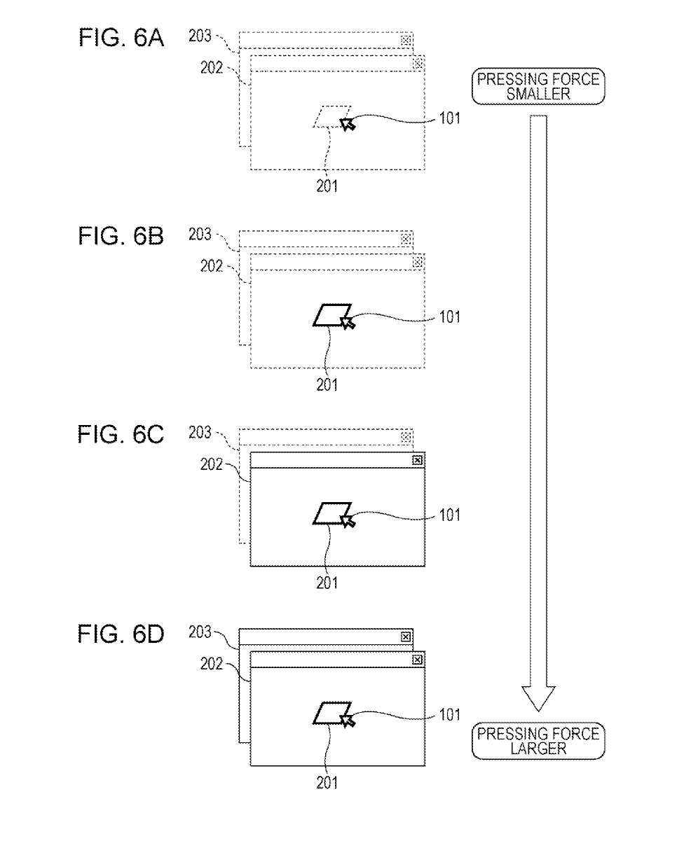

FIG. 6A to FIG. 6D are schematic drawings for explaining an example of the process of the flowchart of FIG. 5, regarding the selection of the object to be moved according to the pressing force, out of the plurality of objects overlapping on the screen 11. In FIG. 6A to FIG. 6D, the designated objects not selected yet are indicated by dot lines.

Three objects 201 to 203 are located at the position overlapping a cursor 101. The three objects 201 to 203 are each identified as the designated object. The objects 202 and 203 are windows, and the object 201 is a pattern located inside the object 202 (window). The object 201 (pattern) is at the frontmost position, the object 202 (window) is at the second frontmost position, and the object 203 (window) is at the rearmost position. FIG. 6A represents the non-selection mode, FIG. 6B represents the first mode, FIG. 6C represents the second mode, and FIG. 6D represents the third mode. In the non-selection mode (FIG. 6A), none of the objects 201 to 203 located at the position overlapping the cursor 101 are selected as the object to be moved. In the first mode (FIG. 6B), only the frontmost object 201 is selected as the object to be moved. In the second mode (FIG. 6C), the frontmost object 201 and the second frontmost object 202 are selected as the object to be moved, but the object 203 is not selected as the object to be moved. In the third mode (FIG. 6D), all of the objects 201 to 203 are selected as the object to be moved.

FIG. 7 is a flowchart for explaining further details of the process of ST250 in the flowchart of FIG. 4, regarding the presentation of the tactile feeling.

The control unit 40 decides the number of designated objects selected as the object to be moved (ST400, ST410, and ST420). In the case where no designated object has been selected as the object to be moved (Yes at ST400), the control unit 40 causes the tactile presentation unit 30 to stop presenting the tactile feeling (ST405). In the case where one designated object has been selected as the object to be moved (Yes at ST410), the control unit 40 causes the tactile presentation unit 30 to present relatively light tactile feeling (ST415). In the case where two designated objects have been selected as the object to be moved (Yes at ST420), the control unit 40 causes the tactile presentation unit 30 to present medium tactile feeling (ST425). The medium tactile feeling (ST425) is lower in frequency and larger in amplitude of the oscillation, than the light tactile feeling (ST415). In the case where three or more designated objects have been selected as the object to be moved (No at ST400, ST410, and ST420), the control unit 40 causes the tactile presentation unit 30 to present heavy tactile feeling (ST430). The heavy tactile feeling (ST430) is lower in frequency and larger in amplitude of the oscillation, than the medium tactile feeling (ST425).

As described thus far, in the user interface device 1 according to the first embodiment, the object on the screen 11 designated by the contact made on the input surface 21 is identified as the designated object, on the basis of the detection result of the contact position of the finger or the like, provided by the detection unit 20. In addition, the identified designated object is selected as the object to be moved, according to the pressing force detected by the detection unit 20. Thus, the object to be moved is selected out of the objects on the screen 11, on the basis of the detection result of the contact position and the pressing force on the input surface 21. The mentioned arrangement enables the object to be moved to be selected through an operation as simple as touching and pressing the input surface 21, thereby significantly facilitating the selection of the object to be moved, and improving the user-friendliness.

In the user interface device 1 according to the first embodiment, at least one designated object is selected as the object to be moved, out of the plurality of designated objects, according to the pressing force detected by the detection unit 20. Such an arrangement enables the object to be moved to be selected out of the plurality of designated objects, through an operation as simple as adjusting the pressing force, thereby improving the user-friendliness.

In the user interface device 1 according to the first embodiment, the number of the designated objects to be selected as the object to be moved, out of the plurality of designated objects, is increased with the increase in the pressing force detected by the detection unit. Accordingly, the number of objects to be moved is increased, with the increase in the pressing force applied to the input surface 21. Such an arrangement simplifies the operation to select the object to be moved out of the plurality of designated objects, thereby improving the user-friendliness.

In the user interface device 1 according to the first embodiment, the designated object at the frontmost position, among the plurality of designated objects overlapping each other on the screen 11, is selected as the object to be moved, when the pressing force is relatively small. As the pressing force increases, the selection range is expanded from the designated object at the frontmost position toward the designated objects at the rear position. Accordingly, the number of objects to be moved overlapping each other is increased, with the increase in the pressing force applied to the input surface 21. Such an arrangement simplifies the operation to select the object to be moved out of the plurality of designated objects overlapping on the screen 11, thereby improving the user-friendliness.

With the user interface device 1 according to the first embodiment, at least one designated object is deselected as the object to be moved, according to the pressing force detected by the detection unit 20, and therefore the deselection as the object to be moved can be easily performed.

With the user interface device 1 according to the first embodiment, at least one designated object is deselected as the object to be moved, by making the pressing force detected by the detection unit 20 smaller than the threshold A1, and therefore the deselection as the object to be moved can be easily performed.

With the user interface device 1 according to the first embodiment, at least one designated object is deselected as the object to be moved by stopping touching the input surface 21, and therefore the deselection as the object to be moved can be easily performed.

With the user interface device 1 according to the first embodiment, the user can perceive whether at least one object on the screen 11 has been selected (not in the non-selection mode), depending on whether the tactile presentation unit 30 is presenting the continuous tactile feeling. Such an arrangement enables the user to perceive the situation through the tactile feeling, without the need to constantly watch the objects on the screen 11, thereby making the operation to select the object to be moved more comfortable.

Hereunder, some variations of the user interface device 1 according to the first embodiment will be described.

### First Variation of First Embodiment

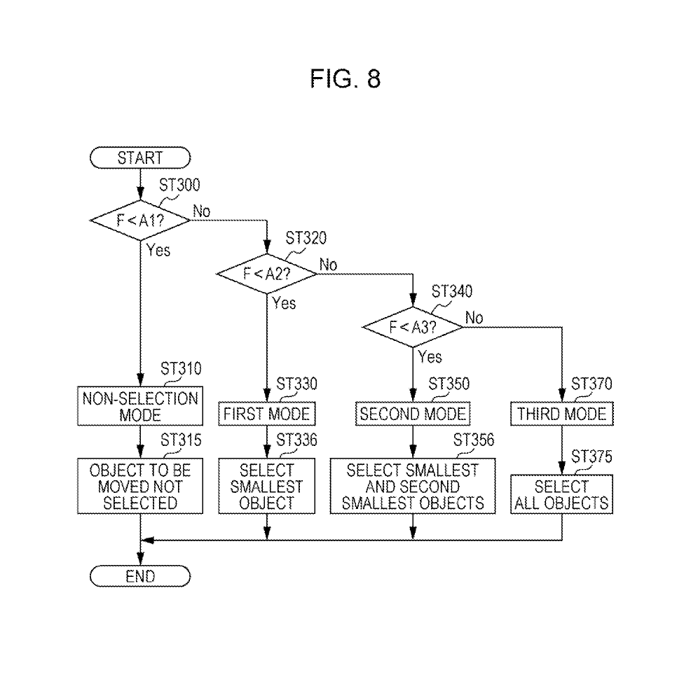

FIG. 8 is a flowchart for explaining a variation of the operation to select the object to be moved according to the pressing force, performed by the user interface device 1 according to the first embodiment. The flowchart of FIG. 8 is different from the flowchart of FIG. 5 in that steps ST335 and ST355 are respectively substituted with steps ST336 and ST356, and the remaining steps of FIG. 8 are the same as those of FIG. 5.

The flowchart of FIG. 8 is different from that of FIG. 5 in the selection method of the object to be moved, in the first mode and the second mode. More specifically, when the plurality of designated objects identified at step ST210 (FIG. 4) are different in area from each other, the control unit 40 expands the selection range of the designated objects to be selected as the object to be moved, from the designated object smallest in area toward the designated object larger in area, with the increase in the pressing force detected by the detection unit.

In the first mode (ST330), the control unit 40 selects the designated object smallest in area, as the object to be moved (ST336), out of the designated objects identified at step ST210. In the case where, for example, two or more designated objects have been identified at step ST210, the control unit 40 selects the designated object smallest in area as the object to be moved, but not the remaining designated objects.

In the second mode (ST350), the control unit 40 selects the designated objects smallest and second smallest in area, as the object to be moved (ST356), out of the designated objects identified at step ST210. In the case where, for example, three or more designated objects have been identified at step ST210, the control unit 40 selects the designated objects smallest and second smallest in area as the object to be moved, but not the remaining designated objects.

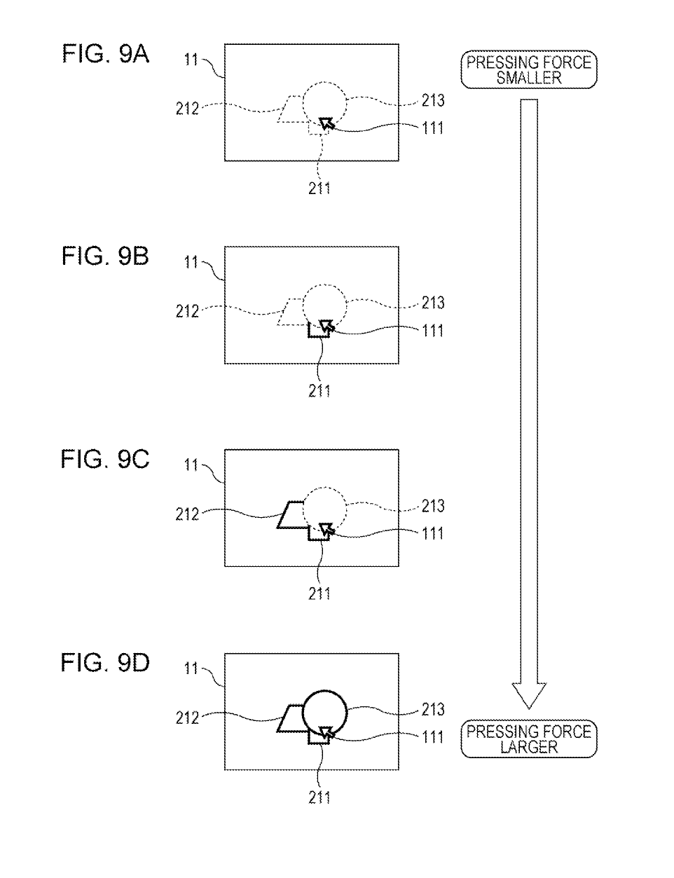

FIG. 9A to FIG. 9D are schematic drawings for explaining an example of the process of the flowchart of FIG. 8, regarding the selection of the designated object to be moved according to the pressing force, out of the plurality of designated objects that are different in area. In these drawings also, the designated objects not selected yet are indicated by dot lines, as in FIG. 6A to FIG. 6D.

In FIG. 9A to FIG. 9D, three objects 211 to 213 of different patterns are located at the position overlapping a cursor 111. The three objects 211 to 213 are each identified as the designated object. The object 211 of a square shape is smallest in area, the object 212 of a parallelogrammatic shape is second smallest in area, and the object 213 of a circular shape is largest in area. FIG. 9A represents the non-selection mode, FIG. 9B represents the first mode, FIG. 9C represents the second mode, and FIG. 9D represents the third mode. In the non-selection mode (FIG. 9A), none of the objects 211 to 213 located at the position overlapping the cursor 111 are selected as the object to be moved. In the first mode (FIG. 9B), only the smallest object 211 is selected as the object to be moved. In the second mode (FIG. 9C), the smallest object 211 and the second smallest object 212 are selected as the object to be moved, but the object 213 is not selected as the object to be moved. In the third mode (FIG. 9D), all of the objects 211 to 213 are selected as the object to be moved.

With the mentioned variation, the designated object smallest in area is selected as the object to be moved, when the pressing force is relatively small. As the pressing force increases, the selection range is expanded from the designated object smallest in area toward the designated objects larger in area. Accordingly, the area of the object to be selected as the object to be moved is increased, with the increase in the pressing force applied to the input surface 21. Such an arrangement simplifies the operation to select the object to be moved out of the plurality of designated objects that are different in area, thereby improving the user-friendliness.

### Second Variation of First Embodiment

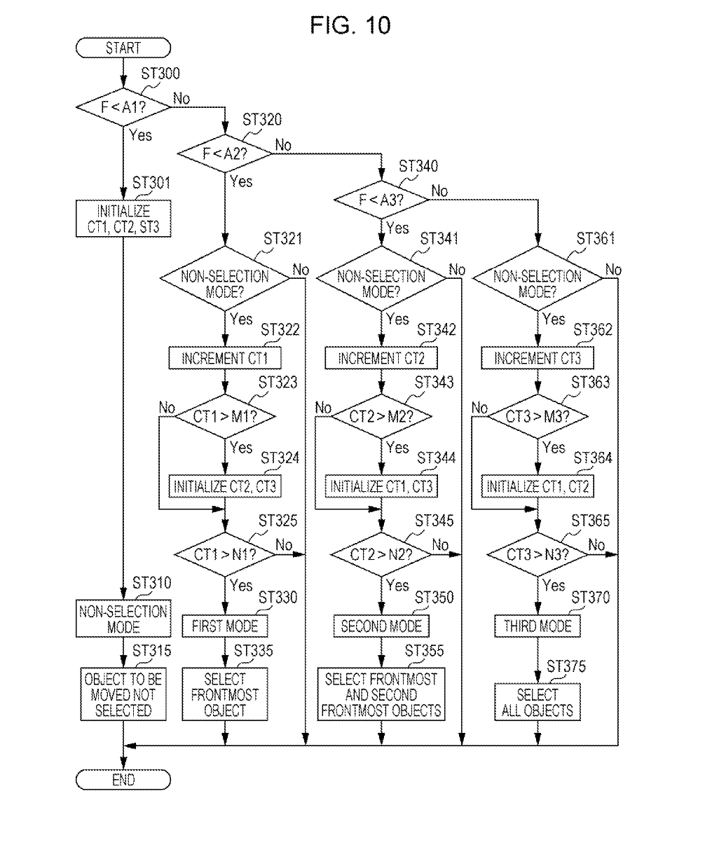

FIG. 10 is a flowchart for explaining another variation of the operation to select the object to be moved according to the pressing force, performed by the user interface device 1 according to the first embodiment. The flowchart of FIG. 10 is different from the flowchart of FIG. 5 in further including step ST301, steps ST321 to ST325, steps ST341 to ST345, and steps ST361 to ST365, and the remaining steps of FIG. 10 are the same as those of FIG. 5.

First, a difference between the flowchart of FIG. 5 and that of FIG. 10 according to this variation will be described.

The flowchart of FIG. 5 specifies three selection criteria regarding the selection of the object to be moved. To be more detailed, the selection criterion for the first mode (ST335) to select the frontmost designated object as the object to be moved, the selection criterion for the second mode (ST355) to select the frontmost and the second frontmost designated objects as the object to be moved, and the selection criterion for the third mode (ST375) to select all the designated objects as the object to be moved, are specified.

In addition, the flowchart of FIG. 5 specifies three conditions corresponding to the respective selection criteria, with respect to the pressing force F. To be more detailed, the condition of the pressing force F corresponding to the selection criterion for the first mode (ST335) is “A1≤F<A2” (hereinafter, “first condition” as the case may be), the condition of the pressing force F corresponding to the selection criterion for the second mode (ST355) is “A2≤F<A3” (hereinafter, “second condition” as the case may be), and the condition of the pressing force F corresponding to the selection criterion for the third mode (ST375) is “A3≤F” (hereinafter, “third condition” as the case may be).

According to the flowchart of FIG. 5, the control unit 40 repeatedly decides which of the three conditions regarding the pressing force F is satisfied. Upon deciding the condition satisfied by the pressing force F, the control unit 40 selects at least one designated object as the object to be moved, according to the selection criterion (first mode to third mode) corresponding to that condition. In the case where none of the three conditions regarding the pressing force F are satisfied, in other words when the pressing force is smaller than the threshold A1, the control unit 40 does not select the object to be moved (non-selection mode).

By the method according to the flowchart of FIG. 5, the selection criterion with respect to the object to be moved is switched, each time the decision result about the condition of the pressing force F is changed. For example, when the pressing force F is increased so as to apply the selection criterion for the third mode, the selection criteria for the first mode and the second mode temporarily become effective, through the process of increasing the pressing force F. When the decision result about the condition of the pressing force F thus varies at short time intervals, the selection criterion for the object to be moved also varies at short time intervals. When the selection criterion for the object to be moved varies at short time intervals, the display on the screen 11, and the presentation of the tactile feeling by the tactile presentation unit 30 are also made to change at short time intervals. Accordingly, this variation additionally includes the steps for preventing the selection criterion from varying at short time intervals.

In this variation, the control unit 40 repeatedly decides which of the plurality of conditions (first condition, second condition, and third condition), corresponding to the respective selection criteria (first mode, second mode, and third mode) is satisfied. The control unit 40 also counts, when no object to be moved has been selected (in the non-selection mode), the number of times that the condition has been decided to be satisfied, as “the number of decision-making times”, with respect to each of the plurality of conditions regarding the pressing force F. When the number of decision-making times counted with respect to a given condition regarding the pressing force F exceeds a predetermined number of times (first number of decisions), the control unit 40 selects at least one designated object as the object to be moved, according to the selection criterion corresponding to that condition. When none of the three conditions regarding the pressing force F are satisfied, in other words when the pressing force is smaller than the threshold A1, the control unit 40 proceeds to the non-selection mode in which no object to be moved is selected, and resets the number of decision-making times counted with respect to each of the conditions, to an initial value.

In this variation, further, when the number of decision-making times counted with respect to a given condition regarding the pressing force F exceeds a predetermined number of times, equal to or fewer than the first number of decisions (second number of decisions), the control unit 40 resets the number of decision-making times counted with respect to the remaining conditions, to the initial value.

Referring to FIG. 10, the specific operation according to this variation will be described.

The control unit 40 compares the pressing force detected by the detection unit 20 with the threshold A1 (ST300). When the pressing force F is smaller than the threshold A1 (Yes at ST300), the control unit 40 proceeds to the “non-selection mode” (ST310). In the non-selection mode, the control unit 40 does not select the object to be moved (ST315). In this case, in addition, the control unit 40 resets the number of decision-making times CT1 counted with respect to the first condition, the number of decision-making times CT2 counted with respect to the second condition, and the number of decision-making times CT3 counted with respect to the third condition, to the initial value (e.g., zero) (ST301).

When the pressing force F satisfies the first condition “A1·F<A2” (No at ST300, Yes at ST320), the control unit 40 decides whether the non-selection mode is set (ST321), and performs the operation of steps ST322 to ST325, ST330, and ST335, in the case where the non-selection mode is set (Yes at ST321). In the case where the non-selection mode is not set (No at ST321), the control unit 40 skips the operation of steps ST322 to ST325, ST330, and ST335, and maintains the current mode.

At step ST322, the control unit 40 increments the number of decision-making times CT1 for the first condition (e.g., increases the value by 1). Upon incrementing the number of decision-making times CT1, the control unit 40 compares between the number of decision-making times CT1 and a second number of decisions M1 (ST323). In the case where the number of decision-making times CT1 is larger than the second number of decisions M1 (Yes at ST323), the control unit 40 resets the number of decision-making times CT2 counted with respect to the second condition, and the number of decision-making times CT3 counted with respect to the third condition, to the initial value (ST324).

After step ST323 and ST324, the control unit 40 compares between the number of decision-making times CT1 and a first number of decisions N1 (ST325). The first number of decisions N1 has a value equal to or larger than the second number of decisions M1. In the case where the number of decision-making times CT1 is larger than the first number of decisions N1 (Yes at ST325), the control unit 40 proceeds to the first mode (ST330). In the first mode, the control unit 40 selects the frontmost designated object as the object to be moved, out of the designated objects identified at step ST210 (FIG. 4) (ST335). In the case where the number of decision-making times CT1 is equal to or smaller than the first number of decisions N1 (No at ST325), the control unit 40 skips the operation of steps ST330 and ST335, and maintains the current mode (non-selection mode).

When the pressing force F satisfies the second condition “A2≤F<A3” (No at ST320, Yes at ST340), the control unit 40 decides whether the non-selection mode is set (ST341), and performs the operation of steps ST342 to ST345, ST350, and ST355, in the case where the non-selection mode is set (Yes at ST341). In the case where the non-selection mode is not set (No at ST341), the control unit 40 skips the operation of steps ST342 to ST345, ST350, and ST355, and maintains the current mode.

At step ST342, the control unit 40 increments the number of decision-making times CT2 for the second condition. Upon incrementing the number of decision-making times CT2, the control unit 40 compares between the number of decision-making times CT2 and a second number of decisions M2 (ST343). In the case where the number of decision-making times CT2 is larger than the second number of decisions M2 (Yes at ST343), the control unit 40 resets the number of decision-making times CT1 counted with respect to the first condition, and the number of decision-making times CT3 counted with respect to the third condition, to the initial value (ST344).

After step ST343 and ST344, the control unit 40 compares between the number of decision-making times CT2 and a first number of decisions N2 (ST345). The first number of decisions N2 has a value equal to or larger than the second number of decisions M2. In the case where the number of decision-making times CT2 is larger than the first number of decisions N2 (Yes at ST345), the control unit 40 proceeds to the second mode (ST350). In the second mode, the control unit 40 selects the frontmost and the second frontmost designated objects as the object to be moved, out of the designated objects identified at step ST210 (FIG. 4) (ST355). In the case where the number of decision-making times CT2 is equal to or smaller than the first number of decisions N2 (No at ST345), the control unit 40 skips the operation of steps ST350 and ST355, and maintains the current mode (non-selection mode).

When the pressing force F satisfies the third condition “A3≤F” (No at ST340), the control unit 40 decides whether the non-selection mode is set (ST361), and performs the operation of steps ST362 to ST365, ST370, and ST375, in the case where the non-selection mode is set (Yes at ST361). In the case where the non-selection mode is not set (No at ST361), the control unit 40 skips the operation of steps ST362 to ST365, ST370, and ST375, and maintains the current mode.

At step ST362, the control unit 40 increments the number of decision-making times CT3 for the third condition. Upon incrementing the number of decision-making times CT3, the control unit 40 compares between the number of decision-making times CT3 and a second number of decisions M3 (ST363). In the case where the number of decision-making times CT3 is larger than the second number of decisions M3 (Yes at ST363), the control unit 40 resets the number of decision-making times CT1 counted with respect to the first condition, and the number of decision-making times CT2 counted with respect to the second condition, to the initial value (ST364).

After step ST363 and ST364, the control unit 40 compares between the number of decision-making times CT3 and a first number of decisions N3 (ST365). The first number of decisions N3 has a value equal to or larger than the second number of decisions M3. In the case where the number of decision-making times CT3 is larger than the first number of decisions N3 (Yes at ST365), the control unit 40 proceeds to the third mode (ST370). In the third mode, the control unit 40 selects all of the designated objects identified at step ST210 (FIG. 4), as the object to be moved (ST375). In the case where the number of decision-making times CT3 is equal to or smaller than the first number of decisions N3 (No at ST365), the control unit 40 skips the operation of steps ST370 and ST375, and maintains the current mode (non-selection mode).

With the mentioned variation, in order for the object to be moved to be selected according to one of the selection criteria, the number of decision-making times (CT1, CT2, CT3), at which it has been decided that one of the conditions corresponding to the one of the selection criteria is satisfied, has to exceed the first number of decisions (N1, N2, N3). Therefore, the selection criteria are prevented from switching at short time intervals, even when the decision result on the conditions related to the pressing force F varies at short time intervals.

With the mentioned variation, in addition, when the number of decision-making times (CT1, CT2, or CT3) counted with respect to a given condition exceeds the second number of decisions (M1, M2, M3) equal to or fewer than the first number of decisions (N1, N2, N3), the number of decision-making times counted with respect to the remaining conditions is reset to the initial value. Accordingly, in the case where the numbers of decision-making times with respect to the respective conditions each increase owing to the variation of the pressing force F, the numbers of decision-making times, with respect to the conditions other than the condition about which the number of decision-making times has first exceeded the second number of decisions, are suppressed from exceeding the first number of decisions. For example, when the number of decision-making times CT1 for the first condition and the number of decision-making times CT2 for the second condition are each increasing, the number of decision-making times CT1 for the first condition and the number of decision-making times CT3 for the third condition are reset to the initial value (e.g., zero), in the case where the number of decision-making times CT2 for the second condition first exceeds the second number of decisions M2. Therefore, the number of decision-making times CT1 for the first condition is restricted from exceeding the first number of decisions N1, and the number of decision-making times CT3 for the third condition is restricted from exceeding the first number of decisions N3. Thus, even when the decision result on the condition of the pressing force F varies owing to the fluctuation of the pressing force F, the number of decision-making times for a given condition is facilitated to exceed the first number of decisions earlier than the number of decision-making times for the remaining conditions, and consequently the selection criterion with respect to the object to be moved can be stably established.

In another variation of this embodiment, when the number of decision-making times (CT1, CT2, CT3) counted with respect to a given condition exceeds the second number of decisions (M1, M2, M3) equal to or fewer than the first number of decisions (N1, N2, N3), the control unit 40 may decrease the number of decision-making times counted with respect to the remaining conditions. Such an arrangement also facilitates the number of decision-making times for a given condition to exceed the first number of decisions, earlier than the number of decision-making times for the remaining conditions.

Further, the control unit 40 may employ an output of a timer circuit, as the count value of the number of decision-making times (CT1, CT2, CT3). In other words, the control unit 40 may use the count value incremented by the timer circuit at predetermined time intervals, from a time point where it is decided that one of the first to the third conditions is satisfied, as the number of decision-making times (CT1, CT2, CT3). The number of decision-making times (CT1, CT2, CT3) thus counted may be approximately regarded as the number of decision-making times counted when the decision on which of the first to the third conditions is satisfied is made, at the predetermined time intervals.

### Third Variation of First Embodiment

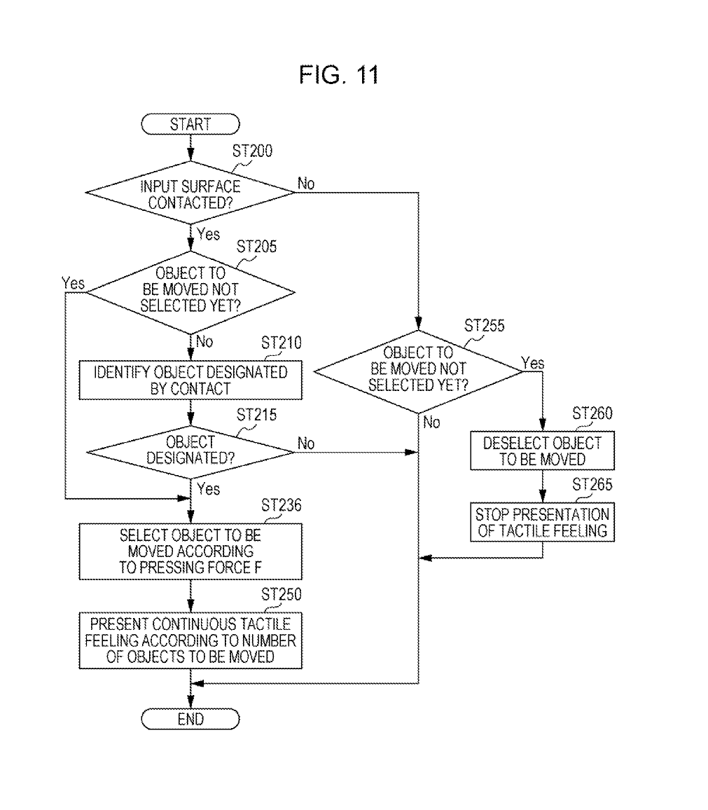

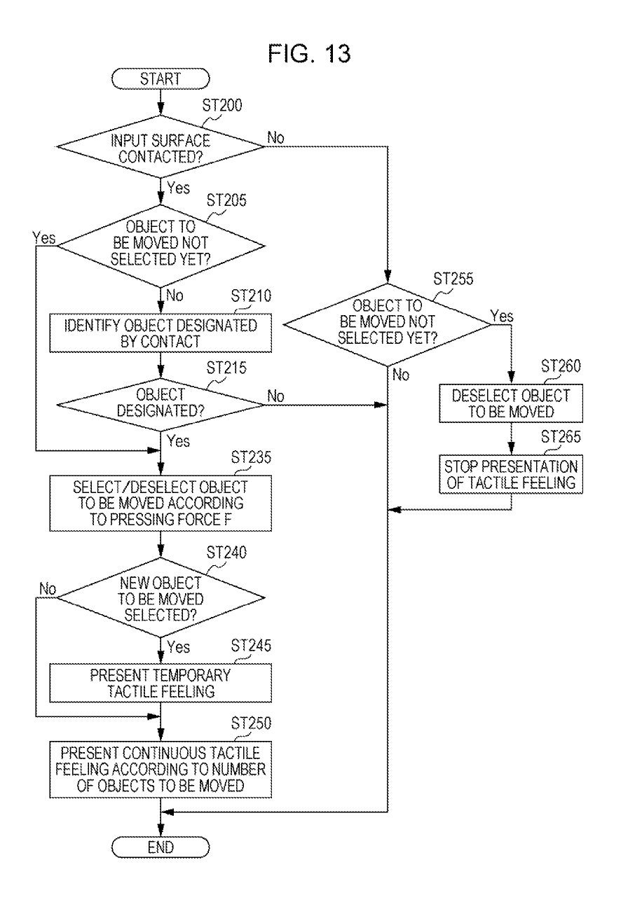

FIG. 11 is a flowchart for explaining still another variation of the operation to select the object to be moved, performed by the user interface device 1 according to the first embodiment. The flowchart of FIG. 11 is different from the flowchart of FIG. 4 in that step ST235 is substituted with step ST236, and the remaining steps of FIG. 13 are the same as those of FIG. 4.

At step ST236, the control unit 40 selects the object to be moved according to the pressing force, but does not deselect the object to be moved according to the pressing force. The control unit 40 deselects the object to be moved at step ST260, reached when the contact on the input surface 21 is suspended. In other words, upon selecting the object to be moved according to the pressing force, the control unit 40 maintains the selection of the object to be moved, until the contact on the input surface 21 is suspended.

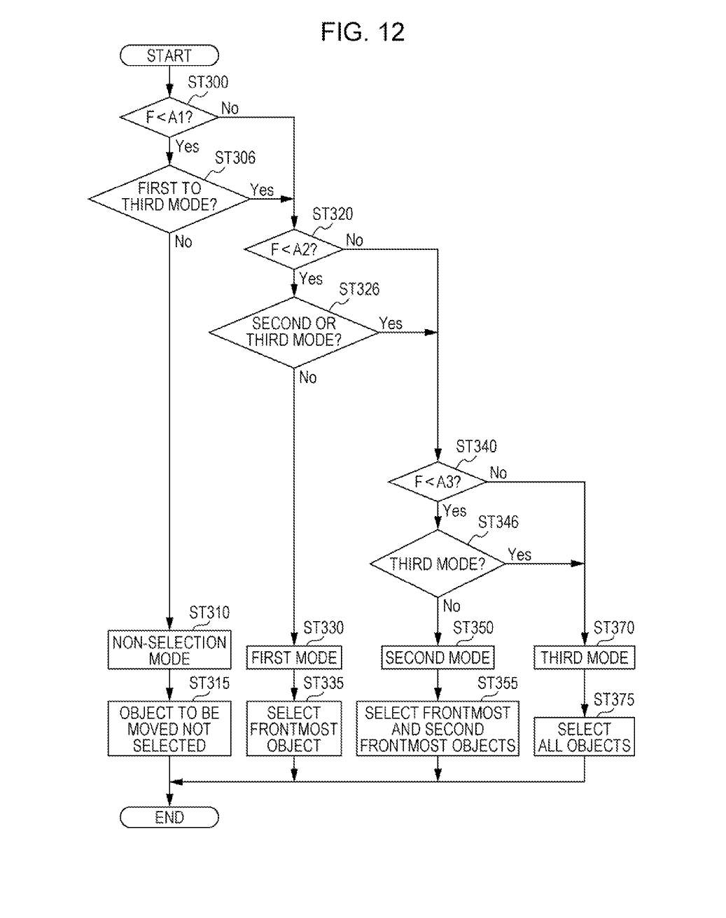

FIG. 12 is a flowchart for explaining further details of the process ST236 in the flowchart of FIG. 11, regarding a variation of the operation to select the object to be moved according to pressing force. The flowchart of FIG. 12 is different from the flowchart of FIG. 5 in further including step ST306, step ST326, and step ST346, and the remaining steps of FIG. 12 are the same as those of FIG. 5.

When the pressing force F is smaller than the threshold A1 at step ST300 (Yes at ST300), the control unit 40 enters the non-selection mode in the case where none of the first to the third modes is set (No at ST306), but proceeds to step ST320 in the case where one of the first to the third modes is set (Yes at ST306). Then, when the pressing force F is smaller than the threshold A2 at step ST320 (Yes at ST320), the control unit 40 enters the first mode in the case where neither of the second and the third modes is set (No at ST326), but proceeds to step ST340 in the case where one of the second and the third modes is set (Yes at ST326). Further, when the pressing force F is smaller than the threshold A3 at step ST340 (Yes at ST340), the control unit 40 enters the second mode in the case where the third modes is not set (No at ST346), but again enters the third mode in the case where the third modes is set (Yes at ST346). Thus, when the mode to select a larger number of objects to be moved is once entered by applying a larger pressing force, such mode is maintained even though the pressing force is reduced thereafter. Therefore, the object to be moved can be prevented from being deselected.

With the mentioned variation, when a larger number of objects to be moved are selected by increasing the pressing force, the selection of the objects to be moved is maintained despite the pressing force being reduced thereafter. Therefore, a plurality of objects can be collectively moved easily, with a small pressing force.

### Fourth Variation of First Embodiment

FIG. 13 is a flowchart for explaining still another variation of the operation to select the object to be moved, performed by the user interface device 1 according to the first embodiment. The flowchart of FIG. 13 is different from the flowchart of FIG. 4 in further including step ST240 and step ST245, and the remaining steps of FIG. 13 are the same as those of FIG. 4.

Upon selecting at least one designated object as the object to be moved, the control unit 40 controls the tactile presentation unit 30 so as to present a temporary tactile feeling for notifying that the selection has been made. To be more detailed, upon selecting a new object to be moved at step ST235 (Yes at ST240), where the object to be moved is selected and deselected according to the pressing force, the control unit 40 controls the tactile presentation unit 30 so as to present a temporary tactile feeling (e.g., temporary oscillation) for notifying that the new object to be moved has been selected (ST245).

The arrangement according to the mentioned variation enables the user to perceive that the new object to be moved has been selected, with the temporary tactile feeling. Therefore, the user can perceive the situation through the tactile feeling, without the need to constantly watch the objects on the screen 11. Thus, the operation to select the object to be moved can be more comfortably performed.

### Second Embodiment

Hereafter, the user interface device 1 according to a second embodiment will be described. In the user interface device 1 according to the second embodiment, the moving speed of the object is changed according to the pressing force. The configuration of the user interface device 1 according to the second embodiment is generally the same as that of the user interface device 1 according to the first embodiment shown in FIGS. 1A and 1B, but the operation of the control unit 40 is different from the first embodiment. The following description will primarily focus on the operation of the control unit 40.

When the contact position detected by the detection unit 20 moves, the control unit 40 moves at least a part of the objects displayed on the screen 11, according to the movement of the contact position. When moving the object on the screen 11 according to the movement of the contact position, the control unit 40 changes the relation between an operation stroke L and an object travel M, according to the pressing force detected by the detection unit 20. The operation stroke L corresponds to a movement distance of the contact position on the input surface 21, and the object travel M corresponds to a movement distance of the object on the screen 11.

For example, the control unit 40 determines the object travel M with respect to the operation stroke L, so that a ratio M/L of the object travel M to the operation stroke L becomes a predetermined value. When the pressing force detected by the detection unit 20 varies, the control unit 40 changes the ratio M/L according to the change of the pressing force.

The control unit 40 reduces the object travel M with respect to a certain fixed operation stroke L, with an increase in the pressing force detected by the detection unit 20. In other words, the control unit 40 decreases the ratio M/L, with the increase in the pressing force.

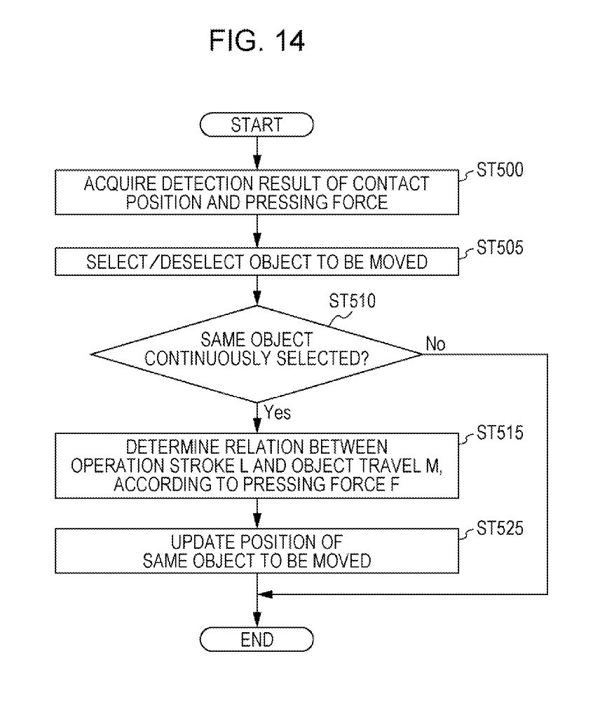

FIG. 14 is a flowchart for explaining an operation of the user interface device 1 according to the second embodiment, performed to move the object on the screen 11 according to the detection result from the detection unit 20. The user interface device 1 repeatedly performs the operation of FIG. 14.

First, the control unit 40 acquires a detection result of the contact position and the pressing force on the input surface 21, from the detection unit 20 (ST500). Upon acquiring the detection result from the detection unit 20, the control unit 40 selects the object to be moved out of the objects displayed on the screen 11, and deselects the object as the object to be moved, on the basis of the detection result (ST505).

At step ST505, the control unit 40 selects and deselects the object to be moved, for example in the same manner as step ST105 (FIG. 3) described earlier.

Alternatively, the control unit 40 may select and deselect the object to be moved by a different method, instead of utilizing the detection result of the pressing force. For example, the control unit 40 may identify an object on the screen 11 as the designated object in the same manner as step ST210 (FIG. 4), and then select the designated object as the object to be moved in the case where the same object has been continuously identified as the designated object for a predetermined time or longer. Otherwise, when the user taps the input surface 21 while an object on the screen 11 is identified as the designated object, the control unit 40 may select such designated object as the object to be moved.

After selecting or deselecting the object to be moved, the control unit 40 updates, in the case where any object to be moved remains selected through the previous and the current process (Yes at ST510), the position of such object to be moved (ST525). For example, the control unit 40 calculates a direction and a distance, in and by which the contact position has moved on the input surface 21, on the basis of the previously detected contact position on the input surface 21 and the currently detected contact position on the input surface 21. The control unit 40 calculates a coordinate on the screen 11 to which the object to be moved is supposed to move, on the basis of the direction and the distance in and by which the contact position has moved, and moves the object to be moved to the coordinate.

To update the position of the object to be moved at step ST525, the control unit 40 determines the relation between the operation stroke L and the object travel M, according to the pressing force F (ST515). The control unit 40 calculates the coordinate on the screen 11 to which the object to be moved is supposed to move, according to the relation between the operation stroke L and the object travel M determined at step ST515 (ST525).

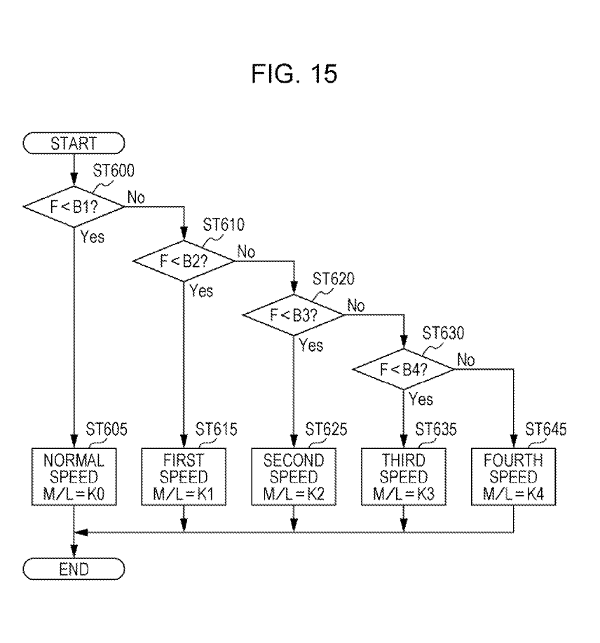

FIG. 15 is a flowchart for explaining further details of the process of ST515 in the flowchart of FIG. 14, regarding changing the relation between the operation stroke L and the object travel M, according to the pressing force F.

The control unit 40 compares the pressing force detected by the detection unit 20, with a threshold B1 (ST600). When the pressing force F is smaller than the threshold B1 (Yes at ST600), the control unit 40 sets a “normal speed”, by adjusting the value of the ratio M/L to “K0” (ST605). The value “K0” is larger than “K1” to “K4” to be subsequently referred to. In the normal speed, the speed of the object with respect to a fixed speed of the contact position on the input surface 21 (hereinafter simply “object speed” as the case may be) is fastest.

When the pressing force F is equal to or larger than the threshold B1 (No at ST600), the control unit 40 compares the pressing force F with a threshold B2 (B2>B1) (ST610). When the pressing force F is smaller than the threshold B2 (Yes at ST610), the control unit 40 sets a “first speed”, by adjusting the value of the ratio M/L to “K1” (K1<K0) (ST615). In the first speed, the object speed is second fastest.

When the pressing force F is equal to or larger than the threshold B2 (No at ST610), the control unit 40 compares the pressing force F with a threshold B3 (B3>B2) (ST620). When the pressing force F is smaller than the threshold B3 (Yes at ST620), the control unit 40 sets a “second speed”, by adjusting the value of the ratio M/L to “K2” (K2<K1) (ST625). In the second speed, the object speed is third fastest.

When the pressing force F is equal to or larger than the threshold B3 (No at ST620), the control unit 40 compares the pressing force F with a threshold B4 (B4>B3) (ST630). When the pressing force F is smaller than the threshold B4 (Yes at ST630), the control unit 40 sets a “third speed”, by adjusting the value of the ratio M/L to “K3” (K3<K2) (ST635). In the third speed, the object speed is second slowest.

When the pressing force F is equal to or larger than the threshold B4 (No at ST630), the control unit 40 sets a “fourth speed”, by adjusting the value of the ratio M/L to “K4” (K4<K3) (ST645). In the fourth speed, the object speed is slowest.

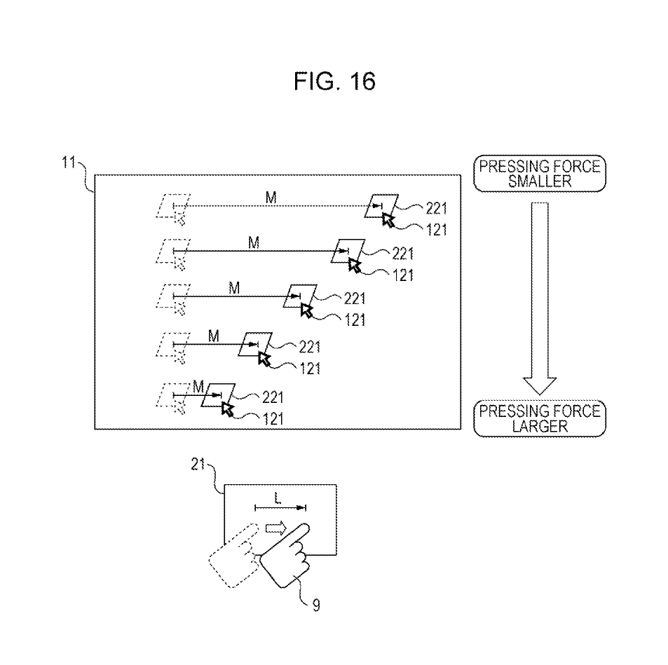

FIG. 16 is a schematic drawing for explaining an example of the process of the flowchart of FIG. 15, for changing the relation between the operation stroke L and the object travel M, according to the pressing force F. A parallelogrammatic object 221 is an object to be moved, on which a cursor 121 is superposed. When the contact position of a user's finger 9 moves on the input surface 21, the object 221 also moves on the screen 11. In the example shown in FIG. 16, the lengths of the object travel M are compared with a fixed operation stroke L, with respect to the normal speed, and the first speed to the fourth speed. Arrows each indicating the object travel M are aligned in the screen 11, in the order of normal speed, first speed, second speed, third speed, and fourth speed, from the top. As is apparent from FIG. 16, the object travel M becomes shorter with respect to the fixed operation stroke L, with an increase in the pressing force.

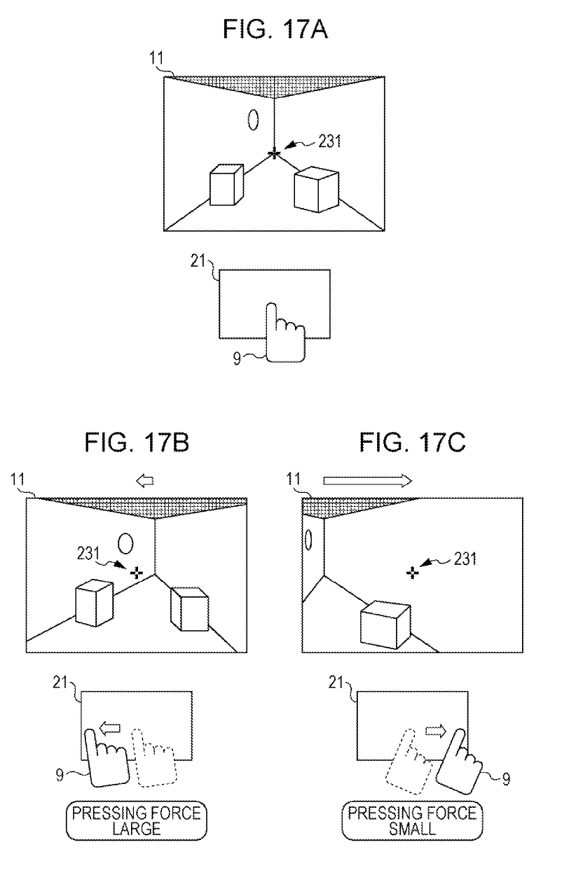

FIG. 17A to FIG. 17C are schematic drawings for explaining another example of the process of the flowchart of FIG. 15, for changing the relation between the operation stroke L and the object travel M, according to the pressing force F. In this example, a sight setting operation on a target is performed in a shooting game. When the contact position of a user's finger 9 moves on the input surface 21, the objects constituting the background collectively move. However, a marker 231 for sight setting is fixed generally at the center of the screen 11. When the display on the screen 11 of FIG. 17A is set as reference, the marker 231 moves to the left with respect to the background (background moves to the right in the screen 11) in FIG. 17B, and the marker 231 moves to the right with respect to the background (background moves to the left in the screen 11) in FIG. 17C. A larger pressing force is applied in FIG. 17B than in FIG. 17C, and therefore subtle adjustment of the sight can be easily performed in FIG. 17B.

As described above, in the user interface device 1 according to the second embodiment, the relation between the operation stroke L and the object travel M is changed according to the pressing force detected by the detection unit 20, when at least a part of the objects displayed on the screen 11 moves so as to follow up the movement of the contact position on the input surface 21. On the assumption that the moving speed of the contact position on the input surface 21 is constant, the longer the object travel M is with respect to the operation stroke L, the faster the object moves, and the shorter the object travel M is with respect to the operation stroke L, the slower the object moves. Therefore, the moving speed of the object can be controlled by adjusting the pressing force. Thus, since the moving speed of the object can be easily adjusted, without the need to go through a troublesome environment setting, the user-friendliness in terms of movement of the object can be improved.

With the user interface device 1 according to the second embodiment, the larger the pressing force is, the longer the object travel M becomes with respect to a fixed operation stroke L. On the assumption that the moving speed of the contact position on the input surface 21 is constant, the larger the pressing force is, the slower the object moves. Therefore, the object can be easily made to move a minute distance.

Hereunder, a variation of the user interface device 1 according to the second embodiment will be described.

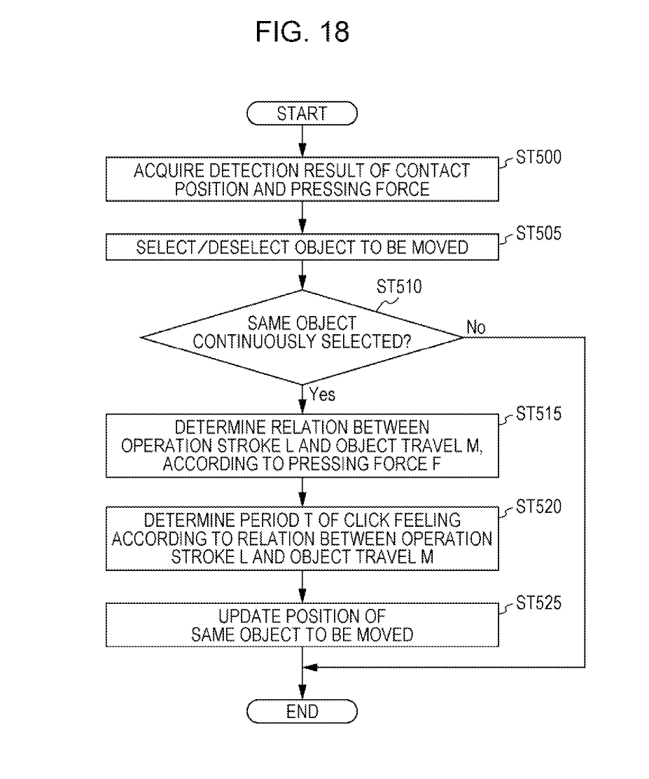

FIG. 18 is a flowchart for explaining a variation of the operation of the user interface device 1 according to the second embodiment. The flowchart of FIG. 18 is different from the flowchart of FIG. 14 in further including step ST520, and the remaining steps of FIG. 18 are the same as those of FIG. 14.

Upon determining the relation between the operation stroke L and the object travel M at step ST515, the control unit 40 controls the tactile presentation unit 30 so as to change the tactile feeling according to the relation between the operation stroke L and the object travel M. More specifically, the control unit 40 controls the tactile presentation unit 30 so as to change the frequency of the click feeling repeatedly transmitted as the tactile feeling, according to the relation between the operation stroke L and the object travel M. For example, the control unit 40 causes the tactile presentation unit 30 to generate periodical click feeling, while the user is moving the object. When the relation between the operation stroke L and the object travel M is changed according to the pressing force F, the control unit 40 also changes the frequency of the click feeling, according to the change of the relation.

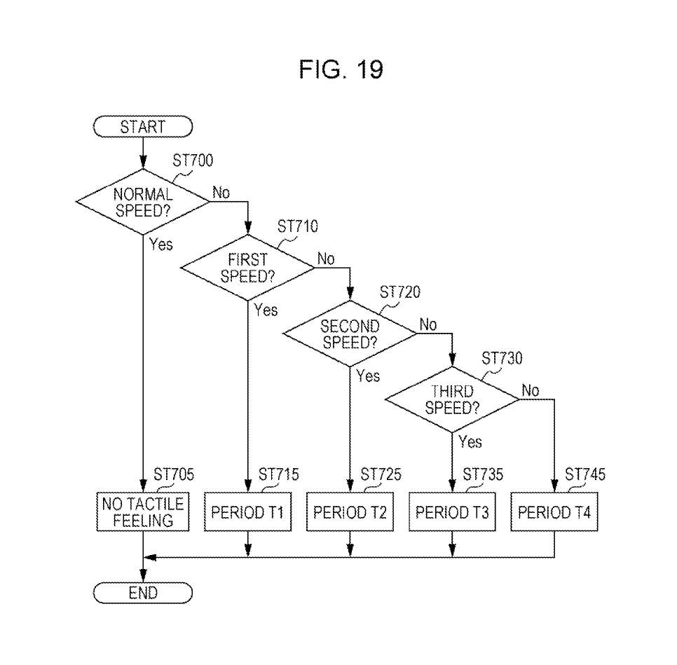

FIG. 19 is a flowchart for explaining further details of the process of ST520 in the flowchart of FIG. 18, regarding the presentation of the tactile feeling.

The control unit 40 checks the state of the ratio M/L determined at step ST515 (ST700, ST710, ST720, ST730). In the case of the normal speed (Yes at ST700), the control unit 40 causes the tactile presentation unit 30 to stop presenting the tactile feeling (ST705). In the case of the first speed (Yes at ST710), the control unit 40 sets the frequency of the click feeling generated by the tactile presentation unit 30 to “T1”. The frequency “T1” is shorter than “T2” to “T4” to be subsequently referred to, and therefore the tempo of the click feeling is fastest, in the first speed. In the case of the second speed (Yes at ST720) the control unit 40 sets the frequency of the click feeling to T2 (T2>T1), sets the frequency of the click feeling to T3 (T3>T2) in the case of the third speed (Yes at ST730), and sets the frequency of the click feeling to T4 (T4>T3) in other cases (No at all of ST700, ST710, ST720, and ST730). The control unit 40 reduces the frequency of the click feeling (slows down the tempo of the click feeling) generated by the tactile presentation unit 30, with a decrease in the value of the ratio M/L.

With the mentioned variation, the user can perceive the relation between the operation stroke L and the object travel M determined according to the pressing force, from the frequency of the click feeling transmitted as the tactile feeling. Such an arrangement enables the user to perceive the situation through the tactile feeling, without the need to constantly watch the objects on the screen 11, thereby making the operation to select the object to be moved more comfortable.

Although the frequency of the click feeling transmitted as the tactile feeling is changed in the foregoing variation, the tactile feeling may be changed in different manners. For example, the control unit 40 may control the tactile presentation unit 30 so as to change the frequency or amplitude of the oscillation transmitted as the tactile feeling, according to the relation between the operation stroke L and the object travel M. More specifically, the control unit 40 may reduce the frequency, or increase the amplitude, of the oscillation generated by the tactile presentation unit 30, with a decrease in the value of the ratio M/L (decrease in the object speed). In this case also, the user can perceive the relation between the operation stroke L and the object travel M from the tactile feeling, and therefore the operation becomes more comfortable, compared with the situation where the user has to constantly watch the screen.

### Third Embodiment

Hereafter, the user interface device 1 according to a third embodiment will be described. In the user interface device 1 according to the third embodiment, the display size of the object is changed according to the pressing force. The configuration of the user interface device 1 according to the third embodiment is generally the same as that of the user interface device 1 according to the first embodiment shown in FIGS. 1A and 1B, but the operation of the control unit 40 is different from the first embodiment. The following description will primarily focus on the operation of the control unit 40.

When a contact position of a finger or the like is detected by the detection unit 20, the control unit 40 identifies at least one object on the screen 11 designated by the contact made on the input surface 21, as the designated object, on the basis of the detected contact position. Upon identifying the designated object, the control unit 40 changes the display size of the designated object, according to the pressing force detected by the detection unit 20.

In an example, the designated object the display size of which is to be changed may be an icon, for example representing a file. Upon identifying the icon on the screen 11 on the basis of the contact position detected by the detection unit 20, the control unit 40 changes the display size of the icon, according to the pressing force detected by the detection unit 20.

In another example, the designated object the display size of which is to be changed may be at least one of icons included in the same folder. Upon identifying a window of the folder on the screen 11 on the basis of the contact position detected by the detection unit 20, the control unit 40 changes the display size of the at least one icon included in the window of the folder, according to the pressing force detected by the detection unit 20.

In still another example, the designated object the display size of which is to be changed may be contents (e.g., image) of a file displayed in a preview window. Upon identifying the file the contents of which are displayed in the preview window as the designated object, or identifying the preview window as the designated object, the control unit 40 changes the display size of the contents of the file in the preview window, according to the pressing force detected by the detection unit 20.

For example, upon identifying the designated object on the basis of the contact position detected by the detection unit 20, the control unit 40 increases display size of the designated object, with an increase in the pressing force detected by the detection unit 20.

In addition, when changing the display size of the designated object according to the pressing force detected by the detection unit 20, the control unit 40 may control the tactile presentation unit 30 so as to change at least one of the frequency and the amplitude of the oscillation transmitted as the tactile feeling, according to the display size of the designated object. For example, the control unit 40 reduces the frequency of the oscillation transmitted as the tactile feeling, with an increase in the display size of the designated object.

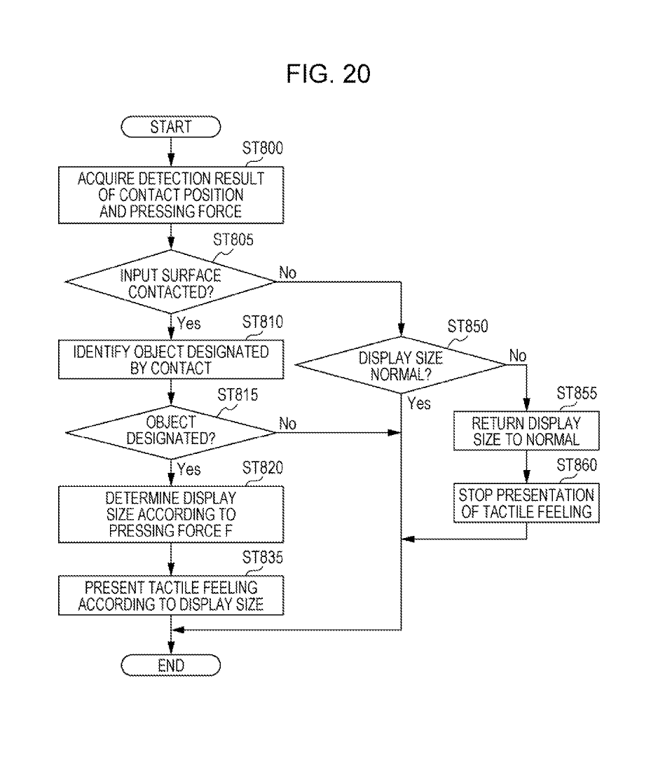

FIG. 20 is a flowchart for explaining an operation of the user interface device 1 according to the third embodiment, performed to change the display size of the object, according to the detection result from the detection unit 20. The user interface device 1 repeatedly perform the process of FIG. 20.

First, the control unit 40 acquires the detection result of the contact position and the pressing force on the input surface 21, from the detection unit 20 (ST800). Upon acquiring the detection result from the detection unit 20, the control unit 40 decides whether a contact has been made on the input surface 21, on the basis of the detection result of the contact position provided by the detection unit 20 (ST805). In the case where a contact has been made on the input surface 21 (Yes at ST805), the control unit 40 identifies the object on the screen 11 designated by the contact, as the designated object (ST810). For example, the control unit 40 identifies the object located at the position overlapping the cursor (pointer) indicating the pointed object, as the designated object. When a plurality of objects are located at the position overlapping the cursor, the control unit 40 may identify each of the plurality of objects, or only the frontmost object, as the designated object.

After step ST810, the control unit 40 decides whether any designated object (object designated by the contact made on the input surface 21) has been identified at step ST810 (ST815). In the case where a designated object has been identified at step ST810 (Yes at ST815), the control unit 40 proceeds to step ST820 and ST835. In contrast, in the case where no designated object has been identified at step ST810 (No at ST815), the control unit 40 finishes the operation instead of proceeding to step ST820 and ST835, because the control unit 40 is unable to select or deselect the object to be moved.

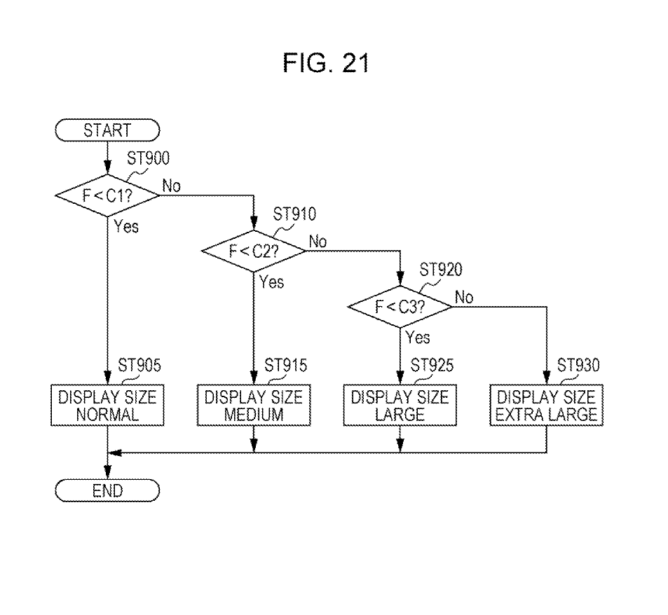

At step ST820, the control unit 40 determines the display size of the designated object, according to the detection result of the pressing force provided by the detection unit 20. Further details of step ST820 will be subsequently described, with reference to FIG. 21.

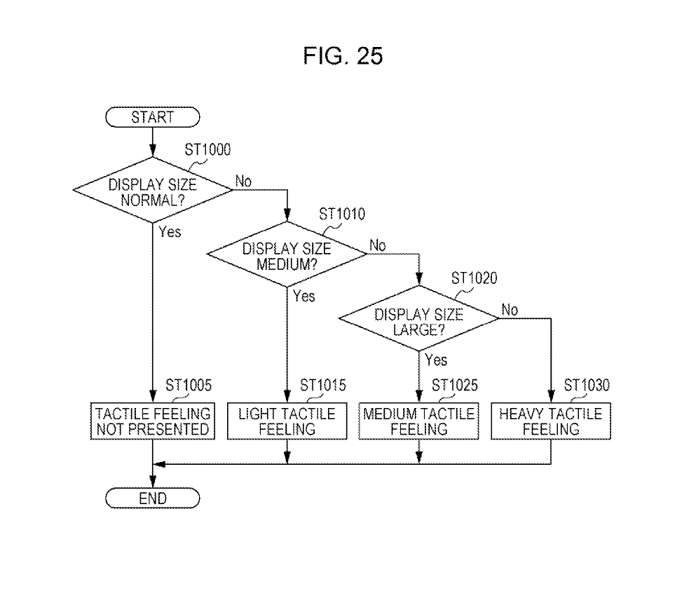

After step ST820, the control unit 40 controls the tactile presentation unit 30 so as to present the tactile feeling according to the display size of the designated object determined at step ST820 (ST835). Further details of step ST835 will be subsequently described, with reference to FIG. 25.

Upon deciding at step ST805 that no contact has been made on the input surface 21 (No at ST805), the control unit 40 decides whether the display size of the designated object is a normal size (ST850). In the case where the display size of the designated object is the normal size (Yes at ST850), the control unit 40 finishes the operation. In contrast, in the case where the display size of the designated object is not the normal size (No at ST850), the control unit 40 returns the display size of the designated object to the normal size (ST855), and causes the tactile presentation unit 30 to stop presenting the tactile feeling (ST860). Therefore, the display size of the designated object can be returned to the normal size, simply by stopping touching the input surface 21.

FIG. 21 is a flowchart for explaining further details of the process of ST820 in the flowchart of FIG. 20, regarding changing the display size of the designated object.

The control unit 40 compares the pressing force detected by the detection unit 20 with a threshold C1 (ST900). When the pressing force F is smaller than the threshold C1 (Yes at ST900), the control unit 40 sets the display size of the designated object to the normal size (ST905). In this embodiment, the normal size is smaller than a medium size, a large size, and an extra-large size to be subsequently referred to.

When the pressing force F is equal to or larger than the threshold C1 (No at ST900), the control unit 40 compares the pressing force F with a threshold C2 (C2>C1) (ST910). When the pressing force F is smaller than the threshold C2 (Yes at ST910), the control unit 40 sets the display size of the designated object to the medium size (ST915). When the pressing force F is equal to or larger than the threshold C2 (No at ST910), the control unit 40 compares the pressing force F with a threshold C3 (C3>C2) (ST920). When the pressing force F is smaller than the threshold C3 (Yes at ST920), the control unit 40 sets the display size of the designated object to the large size (ST925). When the pressing force F is equal to or larger than the threshold C3 (No at ST920), the control unit 40 sets the display size of the designated object to the extra-large size (ST930).

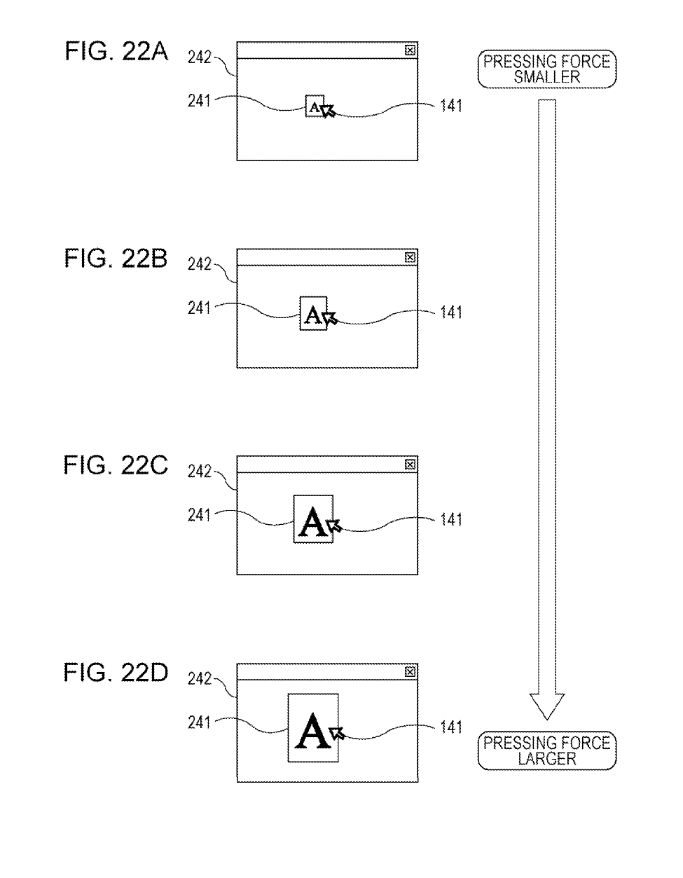

FIG. 22A to FIG. 22D are schematic drawings for explaining an example of the process of the flowchart of FIG. 21, for changing the display size of a specific icon, according to the pressing force. In FIG. 22A to FIG. 22D, a reference numeral 241 denotes an icon, and 242 denotes a window of a folder including the icon 241. Since a cursor 141 is superposed on the icon 241, the control unit 40 changes the display size of the icon 241 according to the pressing force. FIG. 22A, FIG. 22B, FIG. 22C, and FIG. 22D respectively represent the display sizes of normal size, medium size, large size, and extra-large size. As indicated by an arrow on the right, the display size of the icon 241 becomes larger, with the increase in the pressing force. With such an arrangement, the display size of the icon can be easily changed, simply by pressing the icon with the cursor located thereon.

Here, when changing the display size of the icon according to the pressing force, the control unit 40 may also change the display size of the information expressed in characters (e.g., file name, application name) accompanying the icon, in proportion to the icon size.

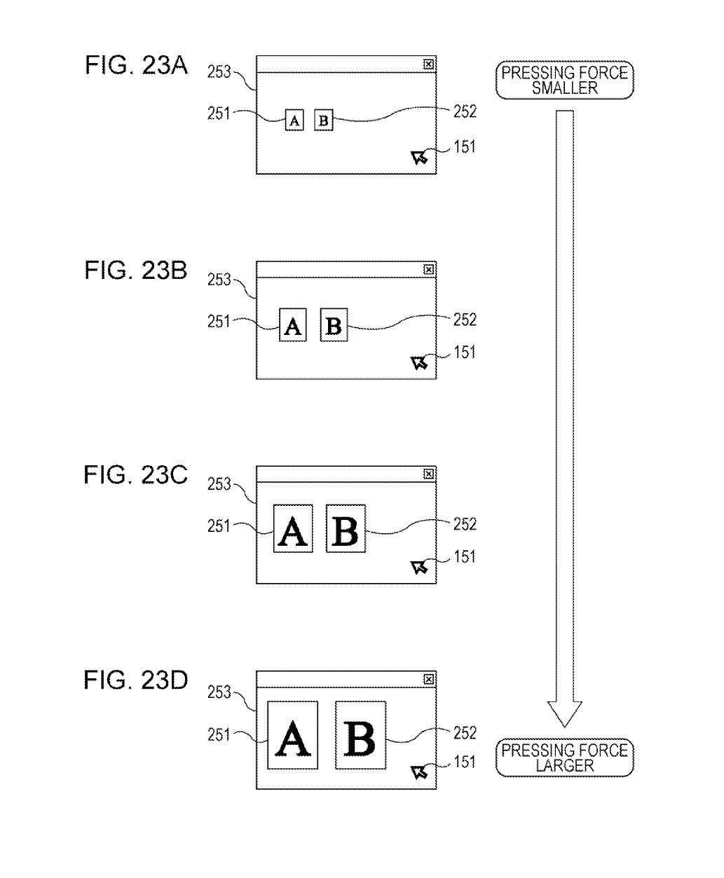

FIG. 23A to FIG. 23D are schematic drawings for explaining another example of the process of the flowchart of FIG. 21, for changing the display size of the icon in the folder, according to the pressing force. In FIG. 23A to FIG. 23D, reference numerals 251 and 252 each denote an icon, and 253 denotes a window of a folder including the icons 251 and 252. Since a cursor 151 is superposed on the window 253 of the folder, the control unit 40 changes the display size of the icons 251 and 252 included in the window 253 of the folder, according to the pressing force. FIG. 23A, FIG. 23B, FIG. 23C, and FIG. 23D respectively represent the display sizes of normal size, medium size, large size, and extra-large size. As indicated by an arrow on the right, the respective display sizes of the icons 251 and 252 become larger, with the increase in the pressing force. With such an arrangement, the display size of the icon can be easily changed, simply by pressing the icon with the cursor located thereon.

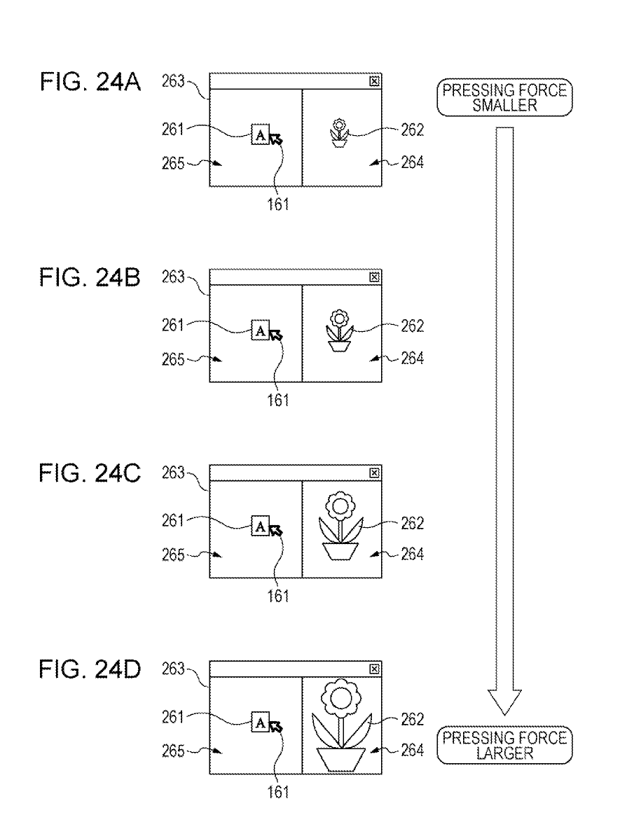

FIG. 24A to FIG. 24D are schematic drawings for explaining another example of the process of the flowchart of FIG. 21, for changing the contents of the file displayed in the preview window, according to the pressing force. In FIG. 24A to FIG. 24D, a reference numeral 261 denotes an icon, and 263 denotes a window. The window 263 includes a folder window 265 and a preview window 264. The icon 261 is included in the folder window 265. In the preview window 265, the content of a file corresponding to the icon 261 (in this example, image of flower 262) is displayed. Since a cursor 151 is superposed on the icon 261, the control unit 40 changes the display size of the content represented by the icon 261 (image 262) displayed in the preview window, according to the pressing force. FIG. 24A, FIG. 24B, FIG. 24C, and FIG. 24D respectively represent the display sizes of normal size, medium size, large size, and extra-large size. As indicated by an arrow on the right, the display size of the image 262 becomes larger, with the increase in the pressing force. With such an arrangement, the display size of the content of the file (e.g., image) displayed in the preview window can be changed, simply by pressing the icon with the cursor located thereon. Thus, the display size of the content of the file in the preview window can be easily changed.

Here, although the designated object designated by the contact made on the input surface 21 (object pointed by the cursor) is the icon 261 in the examples of FIG. 24A to FIG. 24D, the designated object designated by the contact made on the input surface 21 may be the content of the file (image 262) in the preview window, in another example of this embodiment. In other words, also when the content of the file (image 262) in the preview window is directly designated by the contact on the input surface 21 (e.g., when the cursor 161 is located on the image 262), the control unit 40 may change the display size of the content of the file (image 262), according to the pressing force detected by the detection unit 20.

FIG. 25 is a flowchart for explaining further details of the process of ST835 in the flowchart of FIG. 20, regarding the presentation of the tactile feeling.

The control unit 40 checks the display size of the object determined at step ST820 (ST1000, ST1010, and ST1020). When the object is set to the normal size (Yes at ST1000), the control unit 40 causes the tactile presentation unit 30 to stop presenting the tactile feeling (ST1005). When the object is set to the medium size (Yes at ST1010), the control unit 40 causes the tactile presentation unit 30 to present a relatively light tactile feeling (ST1015). When the object is set to the large size (Yes at ST1020), the control unit 40 causes the tactile presentation unit 30 to present a medium tactile feeling (ST1025). The medium tactile feeling (ST1025) is lower in frequency of the oscillation, than the light tactile feeling (ST1015). When the object is set to the extra-large size (No at all of ST1000, ST1010, and ST1020), the control unit 40 causes the tactile presentation unit 30 to present a heavy tactile feeling (ST1030). The heavy tactile feeling (ST1030) is lower in frequency of the oscillation, than the medium tactile feeling (ST1025).

As described above, in the user interface device 1 according to the third embodiment, when at least one object on the screen 11 is identified as the designated object on the basis of the contact position detected by the detection unit 20, the display size of the designated object is changed, according to the pressing force detected by the detection unit 20. In other words, the display size of the object on the screen 11 is changed, on the basis of the contact position and the pressing force on the input surface. The mentioned arrangement enables the display size of the object to be changed through an operation as simple as touching and pressing the input surface 21, thereby significantly facilitating the selection of the object to be moved, and improving the user-friendliness.

Here, the designated object is not limited to the icon, but may be an image or a map displayed in a predetermined area on the screen 11. In such cases, the image or map displayed in the predetermined area can be easily enlarged or reduced, or made to appear farther or closer, according to the pressing force applied to the input surface 21.

With the user interface device 1 according to the third embodiment, the display size of the designated object is increased, with the increase in the pressing force. In other words, the display size is increased with the increase in the pressing force applied to the input surface 21. Such an arrangement simplifies the operation to increase the display size of the object, thereby improving the user-friendliness.

With the user interface device 1 according to the third embodiment, the user can decide whether the display size of the designated object has been changed according to the pressing force, from the oscillation transmitted as the tactile feeling. Such an arrangement enables the user to perceive the situation through the tactile feeling, without the need to constantly watch the objects on the screen 11, thereby making the operation to change the display size of the objects more comfortable.

Hereunder, some variations of the user interface device 1 according to the third embodiment will be described.

### First Variation of Third Embodiment

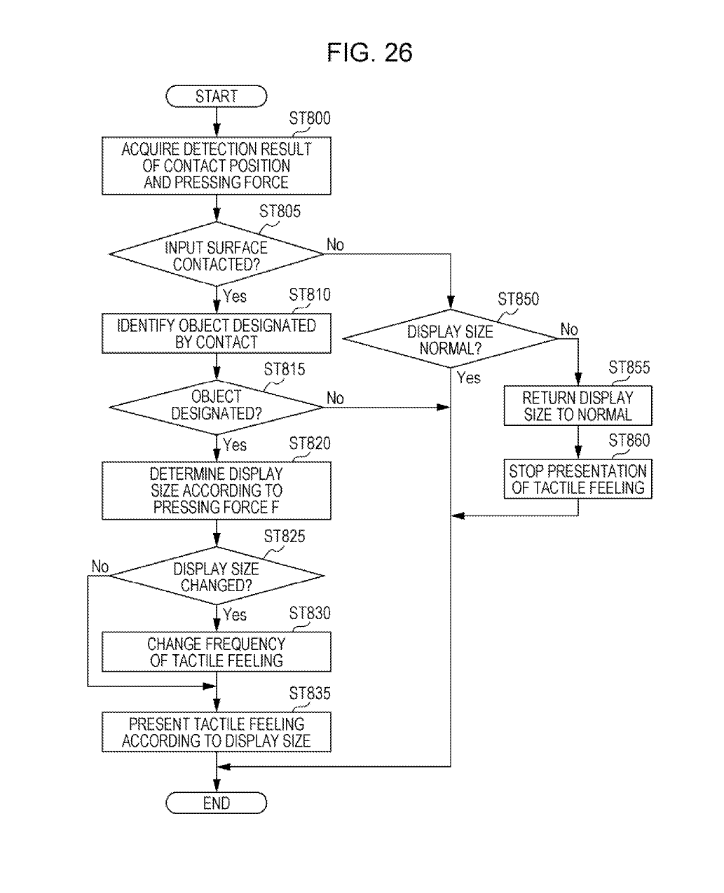

FIG. 26 is a flowchart for explaining a variation of the operation of the user interface device 1 according to the third embodiment. The flowchart of FIG. 26 is different from the flowchart of FIG. 20 in further including steps ST825 and ST830, and the remaining steps of FIG. 26 are the same as those of FIG. 20.

In the case where the display size of the designated object is set according to the pressing force at step ST820, the control unit 40 decides whether the display size of the designated object has been changed by the mentioned setting (ST825). In the case where the display size of the designated object has been changed at step ST820 (Yes at ST825), the control unit 40 changes the frequency of the oscillation generated by the tactile presentation unit 30 as the tactile feeling (ST830). More specifically, the control unit 40 controls the tactile presentation unit 30 so as to reduce the frequency of the oscillation, when increasing the display size of the designated object according to the pressing force detected by the detection unit 20. Conversely, when reducing the display size of the designated object according to the pressing force detected by the detection unit 20, the control unit 40 controls the tactile presentation unit 30 so as to increase the frequency of the oscillation.

The mentioned variation enables the user to perceive that the display size of the designated object has been increased, from the reduction in the frequency of the oscillation transmitted as the tactile feeling. Conversely, the increase in the frequency of the oscillation transmitted as the tactile feeling leads the user to perceive that the display size of the designated object has been reduced. Such an arrangement enables the user to perceive the situation through the tactile feeling, without the need to constantly watch the objects on the screen 11, thereby making the operation related to changing the display size of the objects more comfortable.

### Second Variation of Third Embodiment

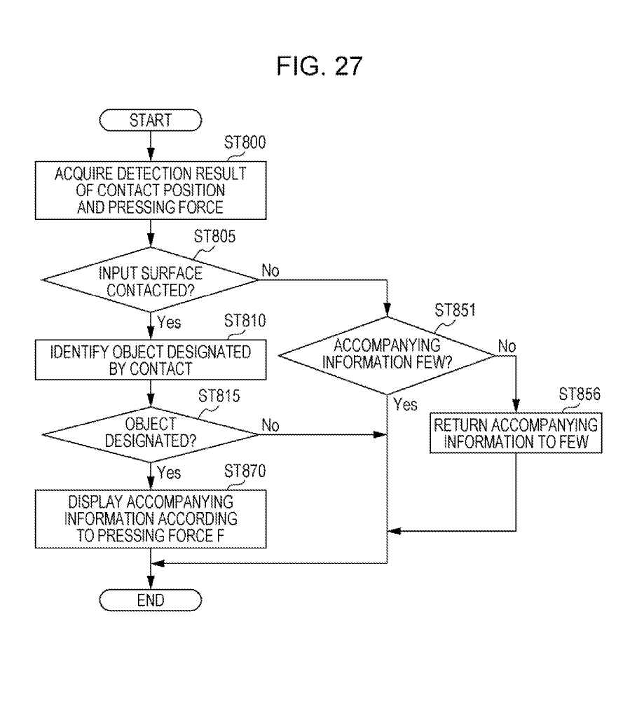

FIG. 27 is a flowchart for explaining another variation of the operation of the user interface device 1 according to the third embodiment. The flowchart of FIG. 27 is different from the flowchart of FIG. 20 in that steps ST820, ST850, and ST855 are respectively substituted with steps ST870, ST851, and ST856, and that steps ST835 and ST860 are deleted. The remaining steps of FIG. 27 are the same as those of FIG. 20.

When the contact position of a finger or the like is detected by the detection unit 20 (Yes at ST800), the control unit 40 identifies the object on the screen 11 designated by the contact on the input surface 21 as the designated object, on the basis of the contact position where the finger has been detected (ST810). Upon identifying the designated object (Yes at ST815), the control unit 40 changes the displayed details of the information accompanying the identified designated object, according to the pressing force detected by the detection unit 20 (ST870).

Examples of the accompanying information of the designated object include information related to the properties of the file (e.g., file name, file making date and time, file updating date and time, and file size), and information related to the contents (e.g., image size in an image file, and duration in a music file).

In an example, the accompanying information the displayed details of which are to be changed is the information displayed in the accompanying information window. Upon identifying a file in which the accompanying information is displayed in the accompanying information window as the designated object, or identifying the accompanying information window as the designated object, the control unit 40 changes the displayed details of the accompanying information in the accompanying information window, according to the pressing force detected by the detection unit 20.

For example, upon identifying the designated object on the basis of the detection result of the contact position provided by the detection unit 20, the control unit 40 increases the displayed details of the accompanying information of the designated object, with an increase in the pressing force detected by the detection unit 20.

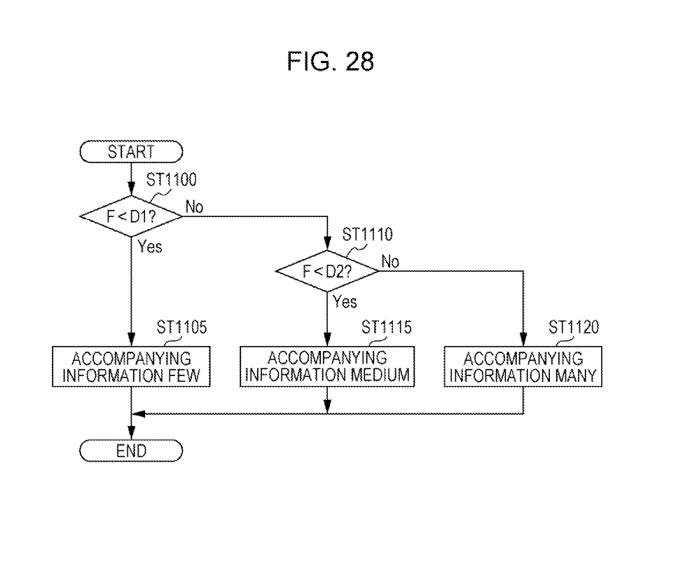

Upon deciding at step ST805 that the input surface 21 has not been contacted (No at ST805), the control unit 40 decides whether the amount of the accompanying information of the designated object is “few” to be subsequently described (step ST1105 in FIG. 28) (ST851). When the displayed amount of the accompanying information is “few” (Yes at ST851), the control unit 40 finishes the operation. In contrast, when the displayed amount of the accompanying information is not “few” (No at ST851), the control unit 40 returns the display of the accompanying information of the designated object to “few” (ST856). Therefore, the display of the accompanying information of the designated object can be reset to the default state (“few”), by stopping touching the input surface 21.

FIG. 28 is a flowchart for explaining further details of the process of ST870 in the flowchart of FIG. 27, regarding changing the displayed details of the accompanying information.

The control unit 40 compares the pressing force detected by the detection unit 20 with a threshold D1 (ST1100). When the pressing force F is smaller than the threshold D1 (Yes at ST1100), the control unit 40 sets the amount of displayed details of the accompanying information of the object to “few” (ST1105). When the pressing force F is equal to or larger than the threshold D1 (No at ST1100), the control unit 40 compares the pressing force F with a threshold D2 (D2>D1) (ST1110). When the pressing force F is smaller than the threshold D2 (Yes at ST1110), the control unit 40 sets the amount of the displayed details of the accompanying information of the object to “medium” (ST1115). A larger number of items are displayed in the “medium” state, than in the “few” state. When the pressing force F is equal to or larger than the threshold D2 (No at ST1110), the control unit 40 sets the amount of the displayed details of the accompanying information of the object to “many” (ST1120). A larger number of items are displayed in the “many” state, than in the “medium” state.

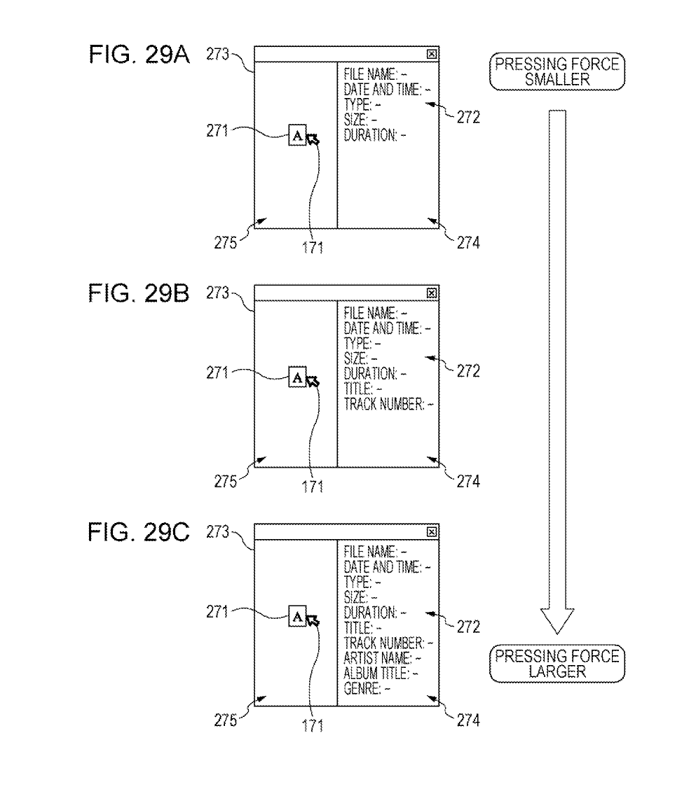

FIG. 29A to FIG. 29C are schematic drawings for explaining an example of the process of the flowchart of FIG. 28, for changing the displayed details of the accompanying information, according to the pressing force. In FIG. 29A to FIG. 29C, a reference numeral 271 denotes an icon, and 273 denotes a window. The window 273 includes a folder window 275 and an accompanying information window 274. The icon 271 is included in the folder window 275. In the accompanying information window 274, accompanying information 272 of a file corresponding to the icon 271 (in this example, music data information) is displayed. Since a cursor 171 is superposed on the icon 271, the control unit 40 changes the displayed details of the accompanying information 272 of the icon 271 displayed in the accompanying information window, according to the pressing force. FIG. 29A, FIG. 29B, and FIG. 29C respectively represent the “few” state, the “medium” state, and the “many” state of the displayed details of the accompanying information. As indicated by an arrow on the right, the amount of the displayed details of the accompanying information is increased, with the increase in the pressing force. With such an arrangement, the amount of the displayed details of the accompanying information 272 displayed in the accompanying information window 274 can be changed, simply by pressing the icon with the cursor located thereon. Thus, the displayed details of the accompanying information in the accompanying information window 274 can be easily changed.

Here, although the designated object designated by the contact made on the input surface 21 (object pointed by the cursor 171) is the icon 271 in the examples of FIG. 29A to FIG. 29C, the designated object designated by the contact made on the input surface 21 may be the accompanying information 272 in the accompanying information window 274, in another example of this embodiment. In other words, also when the accompanying information 272 in the accompanying information window 274 is directly designated by the contact on the input surface 21 (e.g., when the cursor 171 is located on the accompanying information 272), the control unit 40 may change the displayed details of the accompanying information 272, according to the pressing force detected by the detection unit 20.

With the mentioned variation, when at least one object on the screen 11 is identified as the designated object on the basis of the contact position detected by the detection unit 20, the displayed details of the accompanying information of the designated object are changed, according to the pressing force detected by the detection unit 20. In other words, the displayed details of the accompanying information of the object are changed, on the basis of the contact position and the pressing force on the input surface. The mentioned arrangement enables the displayed details of the accompanying information of the object to be changed through an operation as simple as touching and pressing the input surface 21. Thus, the displayed details of the accompanying information of the object can be easily changed, and therefore the user-friendliness can be improved.

With the mentioned variation, in addition, a larger number of items of the accompanying information of the designated object are displayed, with the increase in the pressing force. In other words, the displayed details of the accompanying information are increased, with the increase in the pressing force applied to the input surface 21. Such an arrangement simplifies the operation to increase the amount of the displayed details of the accompanying information, thereby improving the user-friendliness.

The present invention is not limited to the foregoing embodiments, but broadly encompasses different variations.

Although the foregoing embodiments represent the case where the detection unit is configured to detect the contact position and the pressing force, the detection unit may also detect the type of the object that has contacted the input surface. For example, the detection unit may detect whether the object that has contacted the input surface is a finger or another object (e.g., palm). The finger may be detected, for example, on the basis of the contact area of the object on the input surface. When a contact on the input surface by an object other than a finger is detected, the control unit may suspend the display control of the screen based on the pressing force, performed according to the foregoing embodiments. Such an arrangement prevents an unintended display control of the screen (e.g., moving the object, change of the display size of the object, and so forth) from being performed, owing to a contact or pressing by an object other than the finger (e.g., palm).

Although the detection of the contact position on the input surface is based on the electrostatic capacitance in the foregoing embodiments, the contact position may be detected by different methods. To detect the contact position, at least one of the methods known to persons skilled in the art may be employed, such as the electrostatic capacitance method, an electromagnetic induction method, a resistive film method, a surface acoustic wave method, and an infrared light method.

Although the piezoelectric elements are employed to detect the pressing force applied to the input surface in the foregoing embodiments, the pressing force may be detected by different methods. To detect the contact position, at least one of the methods known to persons skilled in the art may be employed, such as the piezoelectric method, a distortion gauge method, and an electromagnetic induction method. Alternatively, an electrostatic sensor may be employed so as to detect the pressing force on the basis of information of contact area of a finger on the sensor, or any two or more of the cited detection methods may be combined, to detect the pressing force.

Although the screen of the display device and the input surface of the detection unit are independent from each other in the foregoing embodiments, a known touch panel may be employed, so as to integrate the screen of the display device and the input surface of the detection unit.

Although the user interface device is exemplified by the laptop personal computer in the foregoing embodiments, the user interface device is not limited thereto. The user interface device according to the embodiments is applicable to various apparatuses having a user interface function, examples of which include a desktop PC, a tablet computer, a telephone, a calculator, a game machine, a car navigation system, an automatic vendor, a ticket vending machine, an ATM, and an industrial machine with a control panel.

What is claimed is:

1. A user interface device that controls a display on a screen of a display device, according to a contact on an input surface, the user interface device comprising:
a detector configured to detect a contact position on the input surface and a pressing force applied to the input surface owing to the contact; and
a controller configured to control a display on the screen according a detection result provided by the detector,
wherein the controller is configured to:
identify, as a designated object, at least an object on the screen designated by the contact made on the input surface, on a basis of a detection result of the contact position provided by the detector;
select at least one designated object as an object to be moved, according to the pressing force detected by the detector; and
move, when the contact position moves, with the object to be moved kept selected, the object to be moved on the screen according to the movement of the contact position.

2. The user interface device according to claim 1,
wherein the controller selects at least one designated object as the object to be moved, out of a plurality of the designated objects, according to the pressing force detected by the detector.

3. The user interface device according to claim 2,
wherein the controller increases a number of the designated objects to be selected as the object to be moved out of the plurality of designated objects, with an increase in the pressing force detected by the detector.

4. The user interface device according to claim 3,
wherein the controller expands, when a plurality of the designated objects overlap on the screen, a range of the designated objects to be selected as the object to be moved, from the designated object at a frontmost position toward the designated object at a rear position, with an increase in the pressing force detected by the detector.

5. The user interface device according to claim 3,
wherein the controller expands, when a plurality of the designated objects are different in area, a range of the designated objects to be selected as the object to be moved, from the designated object smallest in area toward the designated object larger in area, with an increase in the pressing force detected by the detector.

6. The user interface device according to claim 1,
wherein a plurality of selection criteria for selecting at least one designated object as the object to be moved are specified, and
the controller is configured to:
repeatedly decide which of a plurality of conditions corresponding to the plurality of selection criteria the pressing force detected by the detector satisfies; and
select, when a number of times of deciding that one of the conditions is satisfied is larger than a first number of decisions, while the object to be moved is not selected, at least one designated object as the object to be moved, according to one of the selection criteria corresponding to the one condition.

7. The user interface device according to claim 6,
wherein the controller is configured to:
count the number of decision-making times with respect to each of the plurality of conditions, while the object to be moved is not selected; and
reset, when the number of decision-making times counted with respect to one of the conditions is larger than a second number of decisions equal to or fewer than the first number of decisions, the number of decision-making times counted with respect to the remaining conditions to an initial value, or decrease a value of the number of decision-making times counted with respect to the remaining conditions.

8. The user interface device according to claim 1,
wherein the controller deselects, when at least one designated object is selected as the object to be moved, the at least one designated object as the object to be moved, according to the pressing force detected by the detector.

9. The user interface device according to claim 8,
wherein the controller deselects, when at least one designated object is selected as the object to be moved, the at least one designated object as the object to be moved, provided that the pressing force detected by the detector is below a predetermined threshold.

10. The user interface device according to claim 1,
wherein the controller deselects, when at least one designated object is selected as the object to be moved, the at least one designated object as the object to be moved, in a case where the detector stops detecting the contact position.

11. The user interface device according to claim 1, further comprising a tactile presentation unit configured to present a tactile feeling on the input surface,
wherein the controller controls the tactile presentation unit, when at least one designated object is selected as the object to be moved, so as to present a continuous tactile feeling to notify that the object to be moved is selected.

12. The user interface device according to claim 11,
wherein the controller controls the tactile presentation unit, when causing the tactile presentation unit to present the continuous tactile feeling, so as to change at least one of frequency and amplitude of oscillation transmitted as the tactile feeling, according to a number of the designated objects to be selected as the object to be moved.

13. The user interface device according to claim 1, further comprising a tactile presentation unit configured to present a tactile feeling on the input surface,
wherein the controller controls the tactile presentation unit, when at least one designated object is selected as the object to be moved, so as to present a temporary tactile feeling for notifying the selection.

14. A user interface device that controls a display on a screen of a display device, according to a contact on an input surface, the user interface device comprising:
a detector configured to detect a contact position on the input surface and a pressing force applied to the input surface owing to the contact; and
a controller configured to control a display on the screen according a detection result provided by the detector,
wherein the controller is configured to:
move, when the contact position detected by the detection unit moves, at least part of the objects displayed on the screen according to the movement of the contact position; and
change, when moving the at least part of the objects, a relation between an operation stroke corresponding to a movement distance of the contact position on the screen and an object travel corresponding to a movement distance of the at least part of the objects, according to the pressing force detected by the detector.

15. The user interface device according to claim 14,
wherein the controller increases the object travel with respect to a certain fixed operation stroke, with an increase in the pressing force detected by the detector.

16. The user interface device according to claim 14, further comprising a tactile presentation unit configured to present a tactile feeling on the input surface,
wherein the controller controls the tactile presentation unit so as to change the tactile feeling according to the relation between the operation stroke and the object travel.

17. The user interface device according to claim 16,
wherein the controller controls the tactile presentation unit so as to change a frequency of click feeling repeatedly transmitted as the tactile feeling, according to the relation between the operation stroke and the object travel.

18. The user interface device according to claim 16,
wherein he controller controls the tactile presentation unit so as to change at least one of frequency and amplitude of oscillation transmitted as the tactile feeling, according to the relation between the operation stroke and the object travel.

19. A user interface device that controls a display on a screen of a display device, according to a contact on an input surface, the user interface device comprising:
a detector configured to detect a contact position on the input surface and a pressing force applied to the input surface owing to the contact; and
a controller configured to control a display on the screen according a detection result provided by the detector,
wherein the controller is configured to:
identify, as a designated object, at least an object on the screen designated by the contact made on the input surface, on a basis of a detection result of the contact position provided by the detector;
select at least one designated object as an object to be moved, according to the pressing force detected by the detector; and
change at least one of a display size of the at least one designated object and displayed details of information accompanying the at least one designated object, according to the pressing force detected by the detector.

20. The user interface device according to claim 19,
wherein the controller increases the display size of at least one designated object, with an increase in the pressing force detected by the detector.

21. The user interface device according to claim 19,
wherein the controller changes, when an icon is identified as the designated object, the display size of the icon, according to the pressing force detected by the detector.

22. The user interface device according to claim 19,
wherein the controller changes, when a window of a folder is identified as the designated object, the display size of at least one of icons included in the window of the folder, according to the pressing force detected by the detector.

23. The user interface device according to claim 19,
wherein the controller changes, when a file with contents displayed on a preview window is identified as the designated object, or the preview window is identified as the designated object, the display size of the contents of the file in the preview window, according to the pressing force detected by the detector.

24. The user interface device according to claim 19, further comprising a tactile presentation unit configured to present a tactile feeling on the input surface,
wherein the controller controls the tactile presentation unit, when changing the display size of at least one designated object according to the pressing force detected by the detector, so as to change at least one of frequency and amplitude of oscillation transmitted as the tactile feeling, according to the display size of the at least one designated object.

25. The user interface device according to claim 24,
wherein the controller is configured to:
control the tactile presentation unit so as to decrease the frequency of the oscillation, when increasing the display size of the at least one designated object according to the pressing force detected by the detector; and
increase the frequency of the oscillation, when reducing the display size of the at least one designated object according to the pressing force detected by the detector.

26. The user interface device according to claim 19,
wherein the controller increases the displayed details of the information accompanying at least one designated object, with an increase in the pressing force detected by the detector.

27. The user interface device according to claim 19,
wherein the controller changes, when a file including an accompanying information window displaying the accompanying information is identified as the designated object, or when the accompanying information window is identified as the designated object, the displayed details of the accompanying information in the accompanying information window, according to the pressing force detected by the detector.

28. A display control method for controlling a display on a screen of a display device, according to a contact on an input surface, the display control method comprising:
acquiring a detection result from a detector configured to detect a contact position on the input surface and a pressing force applied to the input surface owing to the contact;
identifying, as a designated object, at least an object on the screen designated by the contact made on the input surface, on a basis of the detection result of the contact position provided by the detector;
selecting at least one designated object as an object to be moved, according to the pressing force detected by the detector; and
moving, when the contact position moves, with the object to be moved kept selected, the object to be moved on the screen according to the movement of the contact position.

29. A display control method for controlling a display on a screen of a display device, according to a contact on an input surface, the display control method comprising:
acquiring a detection result from a detector configured to detect a contact position on the input surface and a pressing force applied to the input surface owing to the contact;
moving, when the contact position detected by the detection unit moves, at least part of the objects displayed on the screen according to the movement of the contact position; and
changing, when moving the at least part of the objects, a relation between an operation stroke corresponding to a movement distance of the contact position on the screen and an object travel corresponding to a movement distance of the at least part of the objects, according to the pressing force detected by the detector.

30. A display control method for controlling a display on a screen of a display device, according to a contact on an input surface, the display control method comprising:
acquiring a detection result from a detector configured to detect a contact position on the input surface and a pressing force applied to the input surface owing to the contact;
identifying, as a designated object, at least an object on the screen designated by the contact made on the input surface, on a basis of the detection result of the contact position provided by the detector;
selecting at least one designated object as an object to be moved, according to the pressing force detected by the detector; and
changing at least one of a display size of the at least one designated object and displayed details of information accompanying the at least one designated object, according to the pressing force detected by the detector.

31. A nonvolatile memory having stored therein a program configured to cause a computer to execute the display control method according to claim 28.
